(19) United States
(12) Patent Application Publication
(10) Pub. No.: US 2024/0372669 A1
(43) Pub. Date: Nov. 7, 2024

(54) UPLINK TRANSMISSION WITH EXTENDED UPLINK REFERENCE SIGNAL RESOURCES

(71) Applicant: Telefonaktiebolaget LM Ericsson (publ), Stockholm (SE)

(72) Inventors: Zhipeng Lin, Nanjing (CN); Yufei Blankenship, Kildeer, IL (US); Siva Muruganathan, Stittsville (CA); Shiwei Gao, Nepean (CA)

(21) Appl. No.: 18/685,813

(22) PCT Filed: Jul. 12, 2022
(86) PCT No.: PCT/CN2022/105174

§ 371 Date: Feb. 22, 2024

(30) Foreign Application Priority Data
Aug. 23, 2021 (WO) PCT/CN2021/114080
Aug. 26, 2021 (WO) PCT/CN2021/114841

(51) Int. Cl. H04L 5/00

(52) U.S. Cl. CPC H04L 5/0051

(57) ABSTRACT

The present disclosure is related to a UE, a network node, and methods for uplink transmission with extended uplink reference signal resources. A method at a UE for uplink transmission comprises: receiving, from one or more network nodes, at least one first message indicating at least one of uplink reference signal resources that are configured at the UE and/or indicating an antenna port configuration with up to more than 4 DMRS ports, the number of the configured uplink reference signal resources being up to more than 4 and/or the number of uplink reference signal ports per uplink reference signal resource being up to more than 4; and performing, with at least one of the network nodes, uplink transmission at least partially based on the at least one uplink reference signal resource that is indicated and/or the antenna port configuration that is indicated.

### CROSS-REFERENCE TO RELATED APPLICATION(S)

This application claims priority to the PCT International Application No. PCT/CN2021/114080, entitled “UPLINK TRANSMISSION WITH MULTIPLE CODEWORDS”, filed on Aug. 23, 2021, and the PCT International Application No. PCT/CN2021/114841, entitled “UPLINK TRANSMISSION WITH EXTENDED UPLINK REFERENCE SIGNAL RESOURCES”, filed on Aug. 26, 2021, which are incorporated herein by reference in their entireties.

### TECHNICAL FIELD

The present disclosure is related to the field of telecommunication, and in particular, to a user equipment (UE), a network node, and methods for uplink transmission with extended uplink reference signal resources.

### BACKGROUND

With the development of the electronic and telecommunications technologies, mobile devices, such as mobile phones, smart phones, laptops, tablets, vehicle mounted devices, become an important part of our daily lives. To support a numerous number of mobile devices, a highly efficient Radio Access Network (RAN), such as a fifth generation (5G) New Radio (NR) RAN, will be required.

In order to be able to carry the data across the 5G NR RAN, data and information is organized into a number of data channels. By organizing the data into various channels, a 5G communications system is able to manage the data transfers in an orderly fashion and the system is able to understand what data is arriving and hence it is able to process the data in the required fashion. As there are many different types of data that need to be transferred—user data obviously needs to be transferred, but so does control information to manage the radio communications link, as well as data to provide synchronization, access, and the like. All of these functions are essential and require the transfer of data over the RAN.

In order to group the data to be sent over the 5G NR RAN, the data is organized in a very logical way. As there are many different functions for the data being sent over the radio communications link, they need to be clearly marked and have defined positions and formats. To ensure this happens, there are several different forms of data “channel” that are used. The higher level ones are “mapped” or contained within others until finally at the physical level, the channel contains data from higher level channels.

In this way there is a logical and manageable flow of data from the higher levels of the protocol stack down to the physical layer.

There are three main types of data channels that are used for a 5G RAN, and accordingly the hierarchy is given below.
Logical channel: Logical channels can be one of two groups: control channels and traffic channels:
   Control channels: The control channels are used for the transfer of data from the control plane; and
   Traffic channels: The traffic logical channels are used for the transfer of user plane data.
Transport channel: Is the multiplexing of the logical data to be transported by the physical layer and its channels over the radio interface.
Physical channel: The physical channels are those which are closest to the actual transmission of the data over the radio access network/5G Radio Frequency (RF) signal. They are used to carry the data over the radio interface.

The physical channels often have higher level channels mapped onto them for providing a specific service. Additionally, the physical channels carry payload data or details of specific data transmission characteristics like modulation, reference signal multiplexing, transmit power, RF resources, etc.

The 5G physical channels are used to transport information over the actual radio interface. They have the transport channels mapped into them, but they also include various physical layer data required for the maintenance and optimization of the radio communications link between a UE and a base station (BS).

There are three physical channels for each of the uplink and downlink: Physical Downlink Shared Channel (PDSCH), Physical Downlink Control Channel (PDCCH), and Physical Broadcast Channel (PBCH) for downlink, and Physical Random Access Channel (PRACH), Physical Uplink Shared Channel (PUSCH), and Physical Uplink Control Channel (PUCCH) for uplink.

### SUMMARY

According to a first aspect of the present disclosure, a method at a UE for uplink transmission is provided. The method comprises: receiving, from one or more network nodes, at least one first message indicating at least one of uplink reference signal resources that are configured at the UE and/or indicating an antenna port configuration with up to more than 4 demodulation reference signal (DMRS) ports, the number of the configured uplink reference signal resources being up to more than 4 and/or the number of uplink reference signal ports per uplink reference signal resource being up to more than 4; and performing, with at least one of the network nodes, uplink transmission at least partially based on the at least one uplink reference signal resource that is indicated and/or the antenna port configuration that is indicated.

In some embodiments, before the step of receiving the at least one first message, the method further comprises: transmitting, to the one or more network nodes, one or more uplink reference signals over one or more of the uplink reference signal resources. In some embodiments, the step of performing the uplink transmission comprises: determining a first precoder for the uplink transmission at least partially based on the at least one uplink reference signal resource; and performing the uplink transmission at least partially based on the first precoder. In some embodiments, the one or more uplink reference signals are Sounding Reference Signal (SRS), the uplink reference signal resources are SRS resources, and the uplink reference signal ports are SRS ports. In some embodiments, the at least one first message comprises at least one of: a Downlink Control Information (DCI) message, and a Radio Resource Control (RRC) message.

In some embodiments, the uplink transmission is non-codebook based uplink transmission. In some embodiments, before the step of transmitting the SRSs, the method further comprises: measuring a downlink reference signal transmitted from at least one of the network nodes; and determining a second precoder for SRS transmission at least partially based on one or more measurements of the downlink reference signal, wherein the step of transmitting the SRSs comprises: transmitting the SRSs at least partially based on the second precoder. In some embodiments, the downlink reference signal comprises a Channel State Information—Reference Signal (CSI-RS).

In some embodiments, the at least one first message comprises one or more SRS resource indicator (SRI) fields, at least one of which indicating at least one of the configured SRS resources. In some embodiments, at least one of the SRI fields is capable of indicating a subset of possible combinations of the configured SRS resources. In some embodiments, the at least one SRI field comprises a first number of bits when a second number of SRS resources is configured at the UE, such that the at least one SRI field is not capable of indicating a full set of possible combinations of the configured SRS resources.

In some embodiments, when a maximum number of layers configured at the UE is 2, at least one of following is true:—the at least one SRI field comprises 3 bits when 5 SRS resources are configured at the UE; —the at least one SRI field comprises 3 bits when 6 SRS resources are configured at the UE; —the at least one SRI field comprises 4 bits when 7 SRS resources are configured at the UE; and—the at least one SRI field comprises 4 bits when 8 SRS resources are configured at the UE. In some embodiments, the at least one SRI field is decoded at least partially based on at least one entry of the following table 7.

In some embodiments, when a maximum number of layers configured at the UE is 8, at least one of following is true:—the at least one SRI field comprises 4 bits when 5 SRS resources are configured at the UE; —the at least one SRI field comprises 4 bits when 6 SRS resources are configured at the UE; —the at least one SRI field comprises 5 bits when 7 SRS resources are configured at the UE; and—the at least one SRI field comprises 5 bits when 8 SRS resources are configured at the UE. In some embodiments, the at least one SRI field is decoded at least partially based on at least one entry of the following table 8.

In some embodiments, before the step of receiving the at least one first message, the method further comprises: receiving, from at least one of the network nodes, at least one second message indicating at least one subset of possible combinations of the configured SRS resources. In some embodiments, the at least one second message is a Medium Access Control (MAC) Control Element (CE) message or an RRC message. In some embodiments, the at least one first message indicates at least one of possible combinations of SRS resources in the at least one subset indicated by the at least one second message. In some embodiments, when a maximum number of layers configured at the UE is 8 and 8 SRS resources are configured at the UE, a set of 255 possible combinations of the configured SRS resources is divided into 8 subsets, 7 of the 8 subsets each having 32 possible combinations and 1 of the 8 subsets having 31 possible combinations. In some embodiments, the at least one second message indicates at least one of the 8 subsets. In some embodiments, the at least one SRI field in the at least one first message comprises 5 bits for indicating a possible combination of SRS resources in the at least one subset indicated by the at least one second message.

In some embodiments, the at least one SRI field indicates a first combination of SRS resources when a third number of SRS resources is configured at the UE while the at least one SRI field indicates a second combination of SRS resources when a fourth number of SRS resources is configured at the UE. In some embodiments, the first combination is different from the second combination. In some embodiments, the third number is different from the fourth number. In some embodiments, when a maximum number of layers configured at the UE is 2, at least one of following is true:—the third number is 2 while the fourth number is 5; —the third number is 3 while the fourth number is 6; and—the third number is 4 while the fourth number is 7. In some embodiments, the at least one SRI field is decoded at least partially based on at least one entry of the following table 9.

In some embodiments, the at least one SRI field is decoded at least partially based on at least one entry of at least one table that is different from SRI indication tables in 3GPP NR Rel-16. In some embodiments, the SRS resources configured at the UE is indexed according to a predetermined criterion. In some embodiments, the SRS resources configured at the UE is indexed in an order of channel responses of corresponding downlink reference signals from the strongest to the weakest. In some embodiments, the at least one SRI field is decoded such that at least one SRS resource having an index lower than that of an SRS resource explicitly indicated by the at least one SRI field is considered as being implicitly indicated by the at least one SRI field. In some embodiments, the at least one SRI field is decoded such that any SRS resource having an index lower than that of an SRS resource explicitly indicated by the at least one SRI field is considered as being implicitly indicated by the at least one SRI field.

In some embodiments, the SRS resources configured at the UE comprise at least two subsets of SRS resources, and at least one of the subsets comprises less than or equal to 4 SRS resources. In some embodiments, the at least one first message comprises at least two SRI fields corresponding to the at least two subsets of SRS resources, and at least one of the SRI fields corresponding to the at least one subset comprising less than or equal to 4 SRS resources is decoded at least partially based on at least one entry of an existing SRI indication table in 3GPP NR Rel-16. In some embodiments, the SRS resources configured at the UE comprise at least two subsets of SRS resources, and each of the subsets comprises less than or equal to 4 SRS resources. In some embodiments, the at least one first message comprises at least two SRI fields corresponding to the at least two subsets of SRS resources, and each of the SRI fields corresponding to the corresponding subset is decoded at least partially based on at least one entry of an existing SRI indication table in 3GPP NR Rel-16.

In some embodiments, the SRS resources configured at the UE comprise at least two subsets of SRS resources for at least two of the network nodes, wherein the at least one first message comprises at least two SRI fields corresponding to the at least two subsets of SRS resources, wherein the at least two SRI fields are configured independently of each other. In some embodiments, the at least one first message comprises at least two messages that are received from at least two of the network nodes, respectively. In some embodiments, the at least one first message comprises a single message that is received from at least two of the network nodes in a coordinated manner. In some embodiments, the at least two SRI fields are independently configured by at least two of the network nodes only when the at least two network nodes have different transport blocks (TBs) transmitted.

In some embodiments, the uplink transmission is codebook based uplink transmission. In some embodiments, more than 4 SRS ports are configured at the UE. In some embodiments, the at least one first message comprises one or more SRI fields, at least one of which indicating at least one of the configured SRS resources. In some embodiments, the uplink transmission carries more than one codeword. In some embodiments, the uplink transmission is at least partially based on an antenna port configuration with up to more than 4 Demodulation Reference Signal (DMRS) ports. In some embodiments, the antenna port configuration is at least partially based on antenna port configuration tables with rank greater than 4. In some embodiments, the uplink transmission is Type-1 Configured Grant (CG) based uplink transmission. In some embodiments, the at least one first message is an RRC message comprising one or more SRI fields, at least one of which indicating at least one of the configured SRS resources. In some embodiments, at least one of the one or more SRI fields is comprised in a configuredGrantConfig information element (IE). In some embodiments, the at least one SRI field is an srs-ResourceIndicator-r18IE. In some embodiments, the uplink transmission is PUSCH transmission. In some embodiments, the network node comprises at least a Transmission Reception Point (TRP).

According to a second aspect of the present disclosure, a UE is provided. The UE comprises: a processor; a memory storing instructions which, when executed by the processor, cause the processor to perform the method of any of the first aspect.

According to a third aspect of the present disclosure, a UE is provided. The UE comprises: a receiving module for receiving, from one or more network nodes, at least one first message indicating at least one of uplink reference signal resources that are configured at the UE and/or indicating an antenna port configuration with up to more than 4 DMRS ports, the number of the configured uplink reference signal resources being up to more than 4 and/or the number of uplink reference signal ports per uplink reference signal resource being up to more than 4; and a performing module for performing, with at least one of the network nodes, uplink transmission at least partially based on the at least one uplink reference signal resource that is indicated and/or the antenna port configuration that is indicated.

According to a fourth aspect of the present disclosure, a method at a network node for uplink transmission with a UE is provided. The method comprises: transmitting, to the UE, at least one first message indicating at least one of uplink reference signal resources that are configured at the UE and/or indicating an antenna port configuration with up to more than 4 DMRS ports, the number of the configured uplink reference signal resources being up to more than 4 and/or the number of uplink reference signal ports per uplink reference signal resource being up to more than 4; and receiving, from the UE, uplink transmission at least partially based on the at least one uplink reference signal resource that is indicated and/or the antenna port configuration that is indicated.

In some embodiments, before the step of transmitting the at least one first message, the method further comprises: receiving, from the UE, one or more uplink reference signals over one or more of the uplink reference signal resources. In some embodiments, the one or more uplink reference signals are SRS, the uplink reference signal resources are SRS resources, and the uplink reference signal ports are SRS ports. In some embodiments, the at least one first message comprises at least one of: a DCI message, and an RRC message.

In some embodiments, the uplink transmission is non-codebook based uplink transmission. In some embodiments, before the step of receiving the SRSs, the method further comprises: transmitting, to the UE, a downlink reference signal for the UE to determine a second precoder for SRS transmission. In some embodiments, the downlink reference signal comprises a CSI-RS. In some embodiments, the at least one first message comprises one or more SRI fields, at least one of which indicating at least one of the configured SRS resources. In some embodiments, at least one of the SRI fields is capable of indicating a subset of possible combinations of the configured SRS resources.

In some embodiments, the at least one SRI field comprises a first number of bits when a second number of SRS resources is configured at the UE, such that the at least one SRI field is not capable of indicating a full set of possible combinations of the configured SRS resources.

In some embodiments, when a maximum number of layers configured at the UE is 2, at least one of following is true:—the at least one SRI field comprises 3 bits when 5 SRS resources are configured at the UE; —the at least one SRI field comprises 3 bits when 6 SRS resources are configured at the UE; —the at least one SRI field comprises 4 bits when 7 SRS resources are configured at the UE; and—the at least one SRI field comprises 4 bits when 8 SRS resources are configured at the UE. In some embodiments, the at least one SRI field is encoded at least partially based on at least one entry of the following table 7.

In some embodiments, when a maximum number of layers configured at the UE is 8, at least one of following is true:—the at least one SRI field comprises 4 bits when 5 SRS resources are configured at the UE; —the at least one SRI field comprises 4 bits when 6 SRS resources are configured at the UE; —the at least one SRI field comprises 5 bits when 7 SRS resources are configured at the UE; and—the at least one SRI field comprises 5 bits when 8 SRS resources are configured at the UE. In some embodiments, the at least one SRI field is encoded at least partially based on at least one entry of the following table 8.

In some embodiments, before the step of transmitting the at least one first message, the method further comprises: transmitting, to the UE, at least one second message indicating at least one subset of possible combinations of the configured SRS resources. In some embodiments, the at least one second message is a MAC CE message or an RRC message. In some embodiments, the at least one first message indicates at least one of possible combinations of SRS resources in the at least one subset indicated by the at least one second message. In some embodiments, when a maximum number of layers configured at the UE is 8 and 8 SRS resources are configured at the UE, a set of 255 possible combinations of the configured SRS resources is divided into 8 subsets, 7 of the 8 subsets each having 32 possible combinations and 1 of the 8 subsets having 31 possible combinations. In some embodiments, the at least one second message indicates at least one of the 8 subsets. In some embodiments, the at least one SRI field in the at least one first message comprises 5 bits for indicating a possible combination of SRS resources in the at least one subset indicated by the at least one second message.

In some embodiments, the at least one SRI field indicates a first combination of SRS resources when a third number of SRS resources is configured at the UE while the at least one SRI field indicates a second combination of SRS resources when a fourth number of SRS resources is configured at the UE. In some embodiments, the first combination is different from the second combination. In some embodiments, the third number is different from the fourth number.

In some embodiments, when a maximum number of layers configured at the UE is 2, at least one of following is true:—the third number is 2 while the fourth number is 5; —the third number is 3 while the fourth number is 6; and—the third number is 4 while the fourth number is 7. In some embodiments, the at least one SRI field is encoded at least partially based on at least one entry of the following table 9.

In some embodiments, the at least one SRI field is encoded at least partially based on at least one entry of at least one table that is different from SRI indication tables in 3GPP NR Rel-16. In some embodiments, the SRS resources configured at the UE is indexed according to a predetermined criterion. In some embodiments, the SRS resources configured at the UE is indexed in an order of channel responses of corresponding downlink reference signals from the strongest to the weakest. In some embodiments, the at least one SRI field is encoded such that at least one SRS resource having an index lower than that of an SRS resource explicitly indicated by the at least one SRI field is considered as being implicitly indicated by the at least one SRI field. In some embodiments, the at least one SRI field is encoded such that any SRS resource having an index lower than that of an SRS resource explicitly indicated by the at least one SRI field is considered as being implicitly indicated by the at least one SRI field.

In some embodiments, the SRS resources configured at the UE comprise at least two subsets of SRS resources, and at least one of the subsets comprises less than or equal to 4 SRS resources. In some embodiments, the at least one first message comprises at least two SRI fields corresponding to the at least two subsets of SRS resources, and at least one of the SRI fields corresponding to the at least one subset comprising less than or equal to 4 SRS resources is encoded at least partially based on at least one entry of an existing SRI indication table in 3GPP NR Rel-16. In some embodiments, the SRS resources configured at the UE comprise at least two subsets of SRS resources, and each of the subsets comprises less than or equal to 4 SRS resources. In some embodiments, the at least one first message comprises at least two SRI fields corresponding to the at least two subsets of SRS resources, and each of the SRI fields corresponding to the corresponding subset is encoded at least partially based on at least one entry of an existing SRI indication table in 3GPP NR Rel-16.

In some embodiments, the SRS resources configured at the UE comprise at least two subsets of SRS resources for at least two of the network nodes. In some embodiments, the at least one first message comprises at least two SRI fields corresponding to the at least two subsets of SRS resources. In some embodiments, the at least two SRI fields are configured independently of each other. In some embodiments, the at least one first message comprises at least two messages that are received from at least two of the network nodes, respectively. In some embodiments, the at least one first message comprises a single message that is received from at least two of the network nodes in a coordinated manner. In some embodiments, the at least two SRI fields are independently configured by at least two of the network nodes only when the at least two network nodes have different TBs transmitted.

In some embodiments, the uplink transmission is codebook based uplink transmission. In some embodiments, more than 4 SRS ports are configured at the UE. In some embodiments, the at least one first message comprises one or more SRI fields, at least one of which indicating at least one of the configured SRS resources. In some embodiments, the uplink transmission carries more than one codeword. In some embodiments, the uplink transmission is at least partially based on an antenna port configuration with up to more than 4 DMRS ports. In some embodiments, the antenna port configuration is at least partially based on antenna port configuration tables with rank greater than 4. In some embodiments, the uplink transmission is Type-1 CG based uplink transmission. In some embodiments, the at least one first message is an RRC message comprising one or more SRI fields, at least one of which indicating at least one of the configured SRS resources. In some embodiments, at least one of the one or more SRI fields is comprised in a configuredGrantConfig IE. In some embodiments, the at least one SRI field is an srs-ResourceIndicator-r18IE. In some embodiments, the uplink transmission is PUSCH transmission. In some embodiments, the network node comprises at least a TRP.

According to a fifth aspect of the present disclosure, a network node is provided. The network node comprises: a processor; a memory storing instructions which, when executed by the processor, cause the processor to perform the method of any of the fourth aspect.

According to a sixth aspect of the present disclosure, a network node is provided. The network node comprises: a transmitting module for transmitting, to the UE, at least one first message indicating at least one of uplink reference signal resources that are configured at the UE and/or indicating an antenna port configuration with up to more than 4 DMRS ports, the number of the configured uplink reference signal resources being up to more than 4 and/or the number of uplink reference signal ports per uplink reference signal resource being up to more than 4; and a receiving module for receiving, from the UE, uplink transmission at least partially based on the at least one uplink reference signal resource that is indicated and/or the antenna port configuration that is indicated.

According to a seventh aspect of the present disclosure, a computer program comprising instructions is provided. The instructions, when executed by at least one processor, cause the at least one processor to carry out the method of any of the first or fourth aspect.

According to an eighth aspect of the present disclosure, a carrier containing the computer program of the fifth aspect is provided. The carrier is one of an electronic signal, optical signal, radio signal, or computer readable storage medium.

According to a ninth aspect of the present disclosure, a telecommunications system is provided. The telecommunications system comprises at least one UE of the second or third aspect; and one or more network nodes of the fifth or sixth aspect.

With the above embodiments of the present disclosure, uplink transmission with extended SRS resources is enabled. Further, some embodiments provide methods to support more than 4 SRS resource transmission and/or more than 4 SRS ports per SRS resource for transmission of PUSCH in NR with reduced DCI signaling overhead and SRS resource indication table size. In general, a less signaling overhead, a reduced complexity of system design, a higher throughput, a higher reliability, or a faster response for the uplink transmission may be achieved.

### BRIEF DESCRIPTION OF THE DRAWINGS

FIG. 1 shows flow charts illustrating exemplary Type-1 and Type-2 CG based PUSCH transmission procedures, respectively, with which a UE and gNB according to an embodiment of the present disclosure may be operable.

FIG. 2 shows a flow chart illustrating an exemplary dynamic grant (DG) based PUSCH transmission procedure with which a UE and gNB according to an embodiment of the present disclosure may be operable.

FIG. 3 is a diagram illustrating an exemplary NR time domain structure with 15 kHz subcarrier spacing with which a UE and gNB according to an embodiment of the present disclosure may be operable.

FIG. 4 is a diagram illustrating an exemplary NR physical resource grid with which a UE and gNB according to an embodiment of the present disclosure may be operable.

FIG. 5 is a diagram illustrating exemplary multiplexing of Uplink Control Information (UCI) on PUSCH that is applicable to a UE and gNB according to an embodiment of the present disclosure.

FIG. 6 is a diagram illustrating an exemplary association of rank and SRS resources in a rank nested manner according to an embodiment of the present disclosure.

FIG. 7 is a diagram illustrating an exemplary usage of multiple SRS resource sets for multiple codewords in a same uplink transmission according to an embodiment of the present disclosure.

FIG. 8 is a flow chart illustrating an exemplary method at a UE for uplink transmission with extended uplink reference signal resources according to an embodiment of the present disclosure.

FIG. 9 is a flow chart illustrating an exemplary method at a network node for uplink transmission with extended uplink reference signal resources according to an embodiment of the present disclosure.

FIG. 10 schematically shows an embodiment of an arrangement which may be used in a UE or a network node according to an embodiment of the present disclosure.

FIG. 11 is a block diagram of an exemplary UE according to an embodiment of the present disclosure.

FIG. 12 is a block diagram of an exemplary network node according to an embodiment of the present disclosure.

FIG. 13 schematically illustrates a telecommunication network connected via an intermediate network to a host computer according to an embodiment of the present disclosure.

FIG. 14 is a generalized block diagram of a host computer communicating via a base station with a user equipment over a partially wireless connection according to an embodiment of the present disclosure.

FIG. 15 to FIG. 18 are flowcharts illustrating methods implemented in a communication system including a host computer, a base station, and a user equipment according to an embodiment of the present disclosure.

### DETAILED DESCRIPTION

Hereinafter, the present disclosure is described with reference to embodiments shown in the attached drawings. However, it is to be understood that those descriptions are just provided for illustrative purpose, rather than limiting the present disclosure. Further, in the following, descriptions of known structures and techniques are omitted so as not to unnecessarily obscure the concept of the present disclosure.

Those skilled in the art will appreciate that the term “exemplary” is used herein to mean “illustrative,” or “serving as an example,” and is not intended to imply that a particular embodiment is preferred over another or that a particular feature is essential. Likewise, the terms “first”, “second”, “third”, “fourth,” and similar terms, are used simply to distinguish one particular instance of an item or feature from another, and do not indicate a particular order or arrangement, unless the context clearly indicates otherwise. Further, the term “step,” as used herein, is meant to be synonymous with “operation” or “action.” Any description herein of a sequence of steps does not imply that these operations must be carried out in a particular order, or even that these operations are carried out in any order at all, unless the context or the details of the described operation clearly indicates otherwise.

Conditional language used herein, such as “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment. Also, the term “or” is used in its inclusive sense (and not in its exclusive sense) so that when used, for example, to connect a list of elements, the term “or” means one, some, or all of the elements in the list. Further, the term “each,” as used herein, in addition to having its ordinary meaning, can mean any subset of a set of elements to which the term “each” is applied.

The term “based on” is to be read as “based at least in part on.” The term “one embodiment” and “an embodiment” are to be read as “at least one embodiment.” The term “another embodiment” is to be read as “at least one other embodiment.” Other definitions, explicit and implicit, may be included below. In addition, language such as the phrase “at least one of X, Y and Z,” unless specifically stated otherwise, is to be understood with the context as used in general to convey that an item, term, etc. may be either X, Y, or Z, or a combination thereof.

The terminology used herein is for the purpose of describing particular embodiments only and is not intended to be limitation of example embodiments. As used herein, the singular forms “a”, “an”, and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. It will be also understood that the terms “connect(s),” “connecting”, “connected”, etc. when used herein, just mean that there is an electrical or communicative connection between two elements and they can be connected either directly or indirectly, unless explicitly stated to the contrary.

Of course, the present disclosure may be carried out in other specific ways than those set forth herein without departing from the scope and essential characteristics of the disclosure. One or more of the specific processes discussed below may be carried out in any electronic device comprising one or more appropriately configured processing circuits, which may in some embodiments be embodied in one or more application-specific integrated circuits (ASICs). In some embodiments, these processing circuits may comprise one or more microprocessors, microcontrollers, and/or digital signal processors programmed with appropriate software and/or firmware to carry out one or more of the operations described above, or variants thereof. In some embodiments, these processing circuits may comprise customized hardware to carry out one or more of the functions described above. The present embodiments are, therefore, to be considered in all respects as illustrative and not restrictive.

Although multiple embodiments of the present disclosure will be illustrated in the accompanying Drawings and described in the following Detailed Description, it should be understood that the disclosure is not limited to the disclosed embodiments, but instead is also capable of numerous rearrangements, modifications, and substitutions without departing from the present disclosure that as will be set forth and defined within the claims.

Further, please note that although the following description of some embodiments of the present disclosure is given in the context of 5G NR, the present disclosure is not limited thereto. In fact, as long as uplink transmission with extended uplink reference signal resources is involved, the inventive concept of the present disclosure may be applicable to any appropriate communication architecture, for example, to Global System for Mobile Communications (GSM)/General Packet Radio Service (GPRS), Enhanced Data Rates for GSM Evolution (EDGE), Code Division Multiple Access (CDMA), Wideband CDMA (WCDMA), Time Division—Synchronous CDMA (TD-SCDMA), CDMA2000, Worldwide Interoperability for Microwave Access (WiMAX), Wireless Fidelity (Wi-Fi), 4th Generation Long Term Evolution (LTE), LTE-Advance (LTE-A), or 5G NR, etc. Further, although some embodiments are described with reference to SRS signal, the present disclosure is not limited thereto, and any uplink reference signal (e.g., a possible variant in a future release of 3GPP standards) with a similar function may also be used. Therefore, in some embodiments, the terms “SRS” and “uplink reference signal” may be interchangeably used, and SRS resource/port and uplink reference signal resource/port may also be interchangeably used.

Therefore, one skilled in the arts could readily understand that the terms used herein may also refer to their equivalents in any other infrastructure. For example, the term “User Equipment” or “UE” used herein may refer to a terminal device, a mobile device, a mobile terminal, a mobile station, a user device, a user terminal, a wireless device, a wireless terminal, or any other equivalents. For another example, the term “network node” used herein may refer to a transmission reception point (TRP), a base station, a base transceiver station, an access point, a hot spot, a NodeB, an Evolved NodeB (eNB), a gNB, a network element, or any other equivalents. Further, please note that the term “indicator” used herein may refer to a parameter, a coefficient, an attribute, a property, a setting, a configuration, a profile, an identifier, a field, one or more bits/octets, an information element, or any data by which information of interest may be indicated directly or indirectly.

Further, following 3GPP documents are incorporated herein by reference in their entireties:
3GPP TS 38.211 V16.6.0 (2021-06), 3rd Generation Partnership Project; Technical Specification Group Radio Access Network; NR; Physical channels and modulation (Release 16);
3GPP TS 38.212 V16.6.0 (2021-06), 3rd Generation Partnership Project; Technical Specification Group Radio Access Network; NR; Multiplexing and channel coding (Release 16);
3GPP TS 38.213 V16.6.0 (2021-06), 3rd Generation Partnership Project; Technical Specification Group Radio Access Network; NR; Physical layer procedures for control (Release 16); and
3GPP TS 38.214 V16.6.0 (2021-06), 3rd Generation Partnership Project; Technical Specification Group Radio Access Network; NR; Physical layer procedures for data (Release 16).

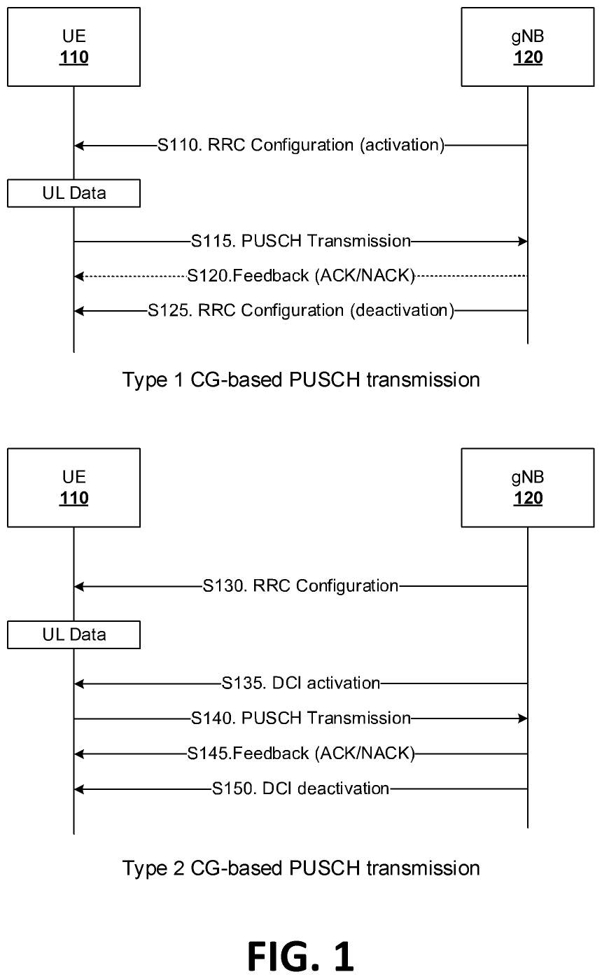

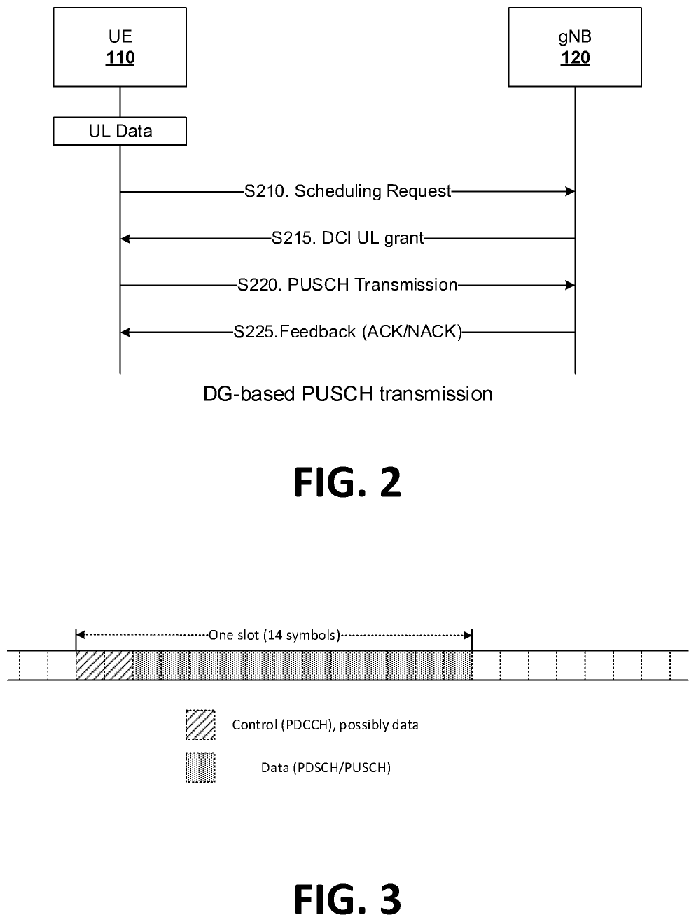

FIG. 1 shows flow charts illustrating exemplary Type-1 and Type-2 CG based PUSCH transmission procedures, respectively, with which the UE 110 and the gNB 120 according to an embodiment of the present disclosure may be operable. FIG. 2 shows a flow chart illustrating an exemplary DG based PUSCH transmission procedure with which the UE 110 and the gNB 120 according to an embodiment of the present disclosure may be operable.

As shown in FIG. 2, a procedure for uplink data transmission based on dynamic UL grant (also known as dynamic scheduling) will be described. Whenever there is UL data to be transmitted from the UE 110 to the gNB 120, the UE 110 may ask the gNB 120 about uplink grant using “scheduling request” message over the PUCCH channel (when UE 110 is in the connected state) or PRACH channel (e.g., when the UE 110 is attempting initial access), as shown at step S210. The gNB 120 may reply the UE 110 with an uplink grant, for example, in a DCI 0_0, DCI 0_1, or DCI 0_2 message over the PDCCH channel at step S215. Upon reception of the uplink grant which may assign the UE 110 with uplink resources for uplink data transmission, the UE 110 may start transmitting the data over the assigned resources over the PUSCH channel at step S220. Upon reception of the UL data, at step S225, the gNB 120 may provide a feedback (ACK/NACK) to the UE 110 such that the UL data may be retransmitted if the initial transmission fails.

However, 5G networks are expected to support applications demanding ultra-reliable and low latency communication (URLLC) services. To support these kinds of applications, 5G-NR introduced grant free uplink transmission feature a.k.a. Transmission without grant (TWG) or Configured Grant (CG) based PUSCH transmission, i.e., data transmission without resource request. Transmission without grant can avoid the regular handshake delay e.g., sending the scheduling request (e.g., step S210) and waiting for UL grant allocation (e.g., step S215). Another advantage is that it may relax the stringent reliability requirements on control channels.

As shown in FIG. 1, a PUSCH channel may be semi-statically (Type-1) or semi-persistently (Type 2) configured by UL grant via RRC (Layer 3) signaling, which is also referred to as grant free configuration scheme. There are two types of grant free configuration schemes supported in 5G NR:
CG Type 1: Uplink grant configuration, activation/deactivation provided by RRC signaling, shown as steps S110 and S125;
CG Type 2: Uplink grant configuration provided via RRC signaling and its activation/deactivation via PDCCH grant (via UL DCIs), shown as steps S135 and S150.

The IE ConfiguredGrantConfig may be used to configure uplink transmission without dynamic grant according to two possible schemes. The actual uplink grant may either be configured via RRC (type1) or provided via the PDCCH (addressed to CS-RNTI) (type2). Multiple Configured Grant configurations may be configured in one Bandwidth Part (BWP) of a serving cell.

CG Type 1 is very much similar to LTE semi-persistent scheduling (SPS) where UL data transmission is based on RRC reconfiguration without any L1 signaling. The gNB 120 may provide the grant configuration to the UE 110 through a higher layer parameter, such as ConfiguredGrantConfig comprising the parameter rrc-ConfiguredUpLinkGrant without the detection of any UL grant in a DCI. Potentially SPS scheduling can provide the suitability for deterministic URLLC traffic pattern, because the traffic properties can be well matched by appropriate resource configuration.

To be specific, at step S110, the gNB 120 may provide an RRC configuration to the UE 110 for activating a semi-static UL resource for the UE 110's UL data transmission. Whenever there is data to be transmitted by the UE 110 to the gNB 120, the UE 110 may use the configured UL resource to deliver the data at step S115. At Step S120, the gNB 120 may implicitly or explicitly provide feedbacks on the data received from the UE 110 with ACK/NACK. For example, in NR CG transmission up to NR Rel-16, there is no explicit ACK feedback from the gNB 120 to the UE 110 for operation in licensed spectrum. In other words, an ACK may be implicitly signaled, and a NACK may be explicitly signaled. A timer T may start when a TB is transmitted, and if no explicit NACK (dynamic grant) is received before the timer T expires the UE assumes ACK, otherwise UE will do retransmission using the dynamic grant provided in DCI with CRC scrambled by CS-RNTI. Furthermore, for operation in unlicensed spectrum, there could be some explicit Hybrid Automatic Repeat Request (HARQ) feedback in DCI, which is called DFI (downlink feedback indication) and only used in DCI format 0-1. However, the present disclosure is not limited thereto. In some other embodiments, an ACK may be explicitly signaled, and a NACK may be implicitly signaled. In some other embodiments, both ACK and NACK may be explicitly signaled.

After the transmission of the data, the gNB 120 may deactivate the semi-statically assigned resource by sending an RRC configuration release or deactivation at step S125.

CG Type 2 is involved an additional L1 signaling (DCI), where uplink is semi-persistently scheduled by an UL grant in a valid activation DCI at step S135. The grant is activated (step S135) and deactivated (step S150) through DCI scrambled with CS-RNTI. RRC only provides a higher layer parameter ConfiguredGrantConfig not comprising rrc-ConfiguredUpLinkGrant (step S130). The DCI signaling can enable fast modification of semi-persistently allocated resources. In this way, it enables the flexibility of UL Grant Free transmission in term of URLLC traffic properties for example packet arrival rate, number of UEs sharing the same resource pool and/or packet size.

Note: Both type 1 and type 2 are configured by RRC per serving cell and per BWP. For the same serving cell, the NR MAC entity may be configured with either Type 1 or Type 2.

There is no specific Activation/Release procedure provided for CG type1. RRC signaling with parameter ConfiguredGrantConfig comprising the parameter rrc-ConfiguredUpLinkGrant implicitly means that CG type 1 is activated. Also, for releasing no dedicated IE is sent by gNB 120, in order to release the CG scheduling configuration, the gNB 120 may just send an RRC reconfiguration release to the UE 110.

CG Type 2 scheduling activation or scheduling release happens via PDCCH decoded DCIs if the CRC of a corresponding DCI format is scrambled with CS-RNTI and the new data indicator field for the enabled transport block is set to “0”. Validation of the DCI format may be achieved if all fields for the DCI format are set according to special fields for UL grant type 2 scheduling activation or scheduling release. If validation is achieved, UE 110 may consider the information in the DCI format as valid activation or valid release of configured UL grant type 2.

NR may use CP-OFDM (Cyclic Prefix—Orthogonal Frequency Division Multiplexing) in both downlink (DL) (i.e. from a network node, gNB, or base station, to a user equipment or UE) and uplink (UL) (i.e. from UE to gNB). Discrete Fourier Transform (DFT) spread OFDM may also be supported in the uplink. In the time domain, NR downlink and uplink may be organized into equally sized subframes of 1 ms each. A subframe may be further divided into multiple slots of equal duration. The slot length may depend on subcarrier spacing. For example, for subcarrier spacing of Δf=15 kHz, there is only one slot per subframe, and each slot may consist of 14 OFDM symbols.

Data scheduling in NR is typically performed in a slot basis, and an example is shown in FIG. 3 with a 14-symbol slot. FIG. 3 is a diagram illustrating an exemplary NR time domain structure with 15 kHz subcarrier spacing with which a UE and gNB according to an embodiment of the present disclosure may be operable. As shown in FIG. 3, the first two symbols may contain PDCCH and the rest may contain physical shared data channel, either PDSCH or PUSCH.

Different subcarrier spacing values may be supported in NR. The supported subcarrier spacing values (also referred to as different numerologies) are given by Δf=(15×2^{μ}) kHz where μ ∈ {0,1,2,3,4}. Δf=15 kHz is the basic subcarrier spacing. The slot durations at different subcarrier spacings are given by ½^{μ} ms.

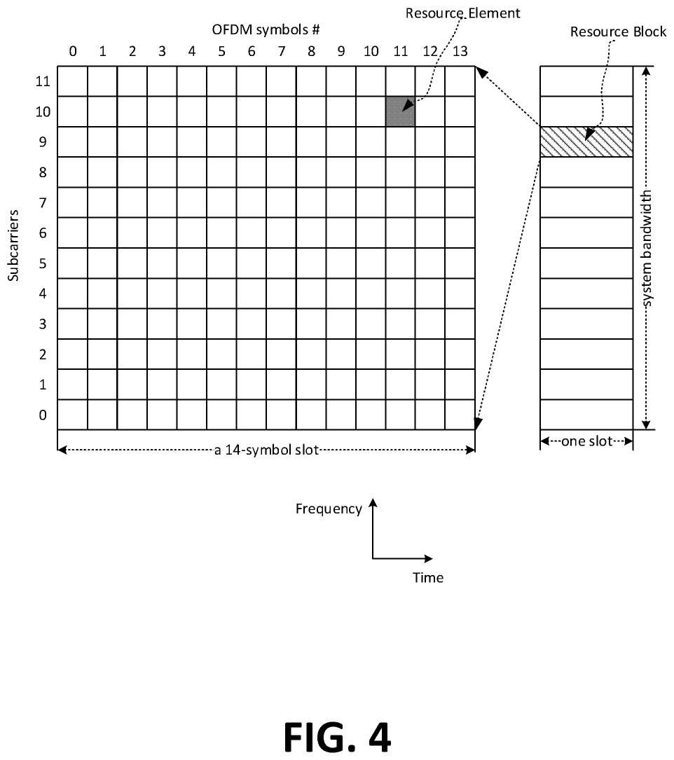

In the frequency domain, a system bandwidth may be divided into resource blocks (RBs), each corresponding to 12 contiguous subcarriers. The RBs are numbered starting with 0 from one end of the system bandwidth. The basic NR physical time-frequency resource grid is illustrated in FIG. 4.

FIG. 4 is a diagram illustrating an exemplary NR physical resource grid with which a UE and gNB according to an embodiment of the present disclosure may be operable. As shown in FIG. 4, only one RB within a 14-symbol slot is shown. One OFDM subcarrier during one OFDM symbol interval forms one resource element (RE).

In NR Rel-15, uplink data transmission can be dynamically scheduled using PDCCH. A UE may first decode uplink grants in PDCCH and then transmits data over PUSCH based the decoded control information in the uplink grant such as modulation order, coding rate, uplink resource allocation, etc. In dynamic scheduling of PUSCH, there is also a possibility to configure semi-persistent transmission of PUSCH using CG as described with reference to FIG. 1. There are two types of CG based PUSCH defined in NR Rel-15. In CG type 1, a periodicity of PUSCH transmission as well as the time domain offset are configured by RRC. In CG type 2, a periodicity of PUSCH transmission may be configured by RRC and then the activation and release of such transmission is controlled by DCI, i.e. with a PDCCH.

Further, in NR, it is possible to schedule a PUSCH with time repetition, by the RRC parameter pusch-AggregationFactor (for dynamically scheduled PUSCH), and repK (for PUSCH with UL configured grant). In this case, the PUSCH is scheduled but transmitted in multiple adjacent slots (if the slot is available for UL) up until the number of repetitions as determined by the configured RRC parameter.

In the case of PUSCH with UL configured grant, the redundancy version (RV) sequence to be used may be configured by the repK-RV field when repetitions are used. If repetitions are not used for PUSCH with UL configured grant, then the repK-RV field is absent.

In NR Release-15, there are two mapping types supported, Type A and Type B, applicable to PDSCH and PUSCH transmissions. Type A is usually referred to as slot-based while Type B transmissions may be referred to as non-slot-based or mini-slot-based.

Mini-slot transmissions can be dynamically scheduled and for NR Rel-15:
Can be of length 7, 4, or 2 symbols for downlink, while it can be of any length for uplink; and
Can start and end in any symbol within a slot.

Please Note that mini-slot transmissions in NR Rel-15 may not cross the slot-border.

Further, one of 2 frequency hopping modes, inter-slot and intra-slot frequency hopping, can be configured via higher layer for PUSCH transmission in NR Rel-15, in IE PUSCH-Config for dynamic transmission or IE configuredGrantConfig for type1 and type2 CG.

In NR, there are two transmission schemes specified for PUSCH, i.e. codebook based and non-codebook based PUSCH transmissions.

The Codebook based UL transmission may be used on both NR and LTE and was motivated to be used for non-calibrated UEs and/or UL FDD (frequency division duplex). Codebook based PUSCH in NR is enabled if higher layer parameter txConfig=codebook. For dynamically scheduled PUSCH and configured grant PUSCH type 2, the Codebook based PUSCH transmission scheme can be summarized as follows:
The UE may transmit one or two SRS resources (i.e., one or two SRS resources configured in the SRS resource set associated with the higher layer parameter usage of value ‘CodeBook’). Note that in NR Rel-15/16, the number of SRS resource sets with higher layer parameter usage set to ‘CodeBook’ is limited to one (i.e., only one SRS resource set is allowed to be configured for the purposes of Codebook based PUSCH transmission).
The gNB may determine a preferred MIMO transmit precoder for PUSCH (i.e., transmit precoding matrix indicator or TPMI) from a codebook and the associated number of layers corresponding to the one or two SRS resources.
The gNB may indicate a selected SRS resource via a 1-bit ‘SRS resource indicator’ field if two SRS resources are configured in the SRS resource set. The ‘SRS resource indicator’ field is not indicated in DCI if only one SRS resource is configured in the SRS resource set.
The gNB may indicate a TPMI and the associated number of layers corresponding to the indicated SRS resource (in case 2 SRS resources are used) or the configured SRS resource (in case of 1 SRS resource is used). TPMI and the number of PUSCH layers may be indicated by the ‘Precoding information and number of layers’ field in DCI formats 0_1 and 0_2. The number of bits in the ‘Precoding information and number of layers’ for Codebook based PUSCH may be determined as follows:
   0 bits if 1 antenna port is used for PUSCH transmission.
   4, 5, or 6 bits according to Table 1 for 4 antenna ports, according to whether transform precoder is enabled or disabled, and the values of higher layer parameters maxRank, and codebookSubset. That is, ‘Precoding information and number of layers’ field size takes values of 6, 5, and 4 bits if codebookSubsetis set to ‘fullyAndPartialAndNonCoherent’, ‘PartialAndNonCoherent’ and ‘NonCoherent’ respectively.

TABLE 1
Precoding information and number of layers, for 4 antenna ports, if
transform precoder is disabled and maxRank = 2 or 3 or 4 and ul-
FullPowerTransmission is not configured or configured to fullpowerMode2 or configured
to fullpower

| Bit field | | Bit field | | Bit field | |
|---|---|---|---|---|---|
| mapped | codebookSubset = | mapped | codebookSubset = | mapped | codebookSubset = |
| to index | fully AndPartialAndNonCoherent | to index | partialAndNonCoherent | to index | nonCoherent |
| 0 | 1 layer: TPMI = 0 | 0 | 1 layer: TPMI = 0 | 0 | 1 layer: TPMI = 0 |
| 1 | 1 layer: TPMI = 1 | 1 | 1 layer: TPMI = 1 | 1 | 1 layer: TPMI = 1 |
| . . . | . . . | . . . | . . . | . . . | . . . |
| 3 | 1 layer: TPMI = 3 | 3 | 1 layer: TPMI = 3 | 3 | 1 layer: TPMI = 3 |
| 4 | 2 layers: TPMI = 0 | 4 | 2 layers: TPMI = 0 | 4 | 2 layers: TPMI = 0 |
| . . . | . . . | . . . | . . . | . . . | . . . |
| 9 | 2 layers: TPMI = 5 | 9 | 2 layers: TPMI = 5 | 9 | 2 layers: TPMI = 5 |
| 10 | 3 layers: TPMI = 0 | 10 | 3 layers: TPMI = 0 | 10 | 3 layers: TPMI = 0 |
| 11 | 4 layers: TPMI = 0 | 11 | 4 layers: TPMI = 0 | 11 | 4 layers: TPMI = 0 |
| 12 | 1 layer: TPMI = 4 | 12 | 1 layer: TPMI = 4 | 12-15 | reserved |
| . . . | . . . | . . . | . . . | | |
| 19 | 1 layer: TPMI = 11 | 19 | 1 layer: TPMI = 11 | | |
| 20 | 2 layers: TPMI = 6 | 20 | 2 layers: TPMI = 6 | | |
| . . . | . . . | . . . | . . . | | |
| 27 | 2 layers: TPMI = 13 | 27 | 2 layers: TPMI = 13 | | |
| 28 | 3 layers: TPMI = 1 | 28 | 3 layers: TPMI = 1 | | |
| 29 | 3 layers: TPMI = 2 | 29 | 3 layers: TPMI = 2 | | |
| 30 | 4 layers: TPMI = 1 | 30 | 4 layers: TPMI = 1 | | |
| 31 | 4 layers: TPMI = 2 | 31 | 4 layers: TPMI = 2 | | |
| 32 | 1 layers: TPMI = 12 | | | | |
| . . . | . . . | | | | |
| 47 | 1 layers: TPMI = 27 | | | | |
| 48 | 2 layers: TPMI = 14 | | | | |
| . . . | . . . | | | | |
| 55 | 2 layers: TPMI = 21 | | | | |
| 56 | 3 layers: TPMI = 3 | | | | |
| . . . | . . . | | | | |
| 59 | 3 layers: TPMI = 6 | | | | |
| 60 | 4 layers: TPMI = 3 | | | | |
| 61 | 4 layers: TPMI = 4 | | | | |
| 62-63 | reserved | | | | |

2, 4, or 5 bits according to Table 2 for 4 antenna ports, according to whether transform precoder is enabled or disabled, and the values of higher layer parameters maxRank, and codebookSubset. That is, ‘Precoding information and number of layers’ field size takes values of 5, 4, and 2 bits if codebookSubset is set to ‘fullyAndPartiaiAndNonCoherent’, ‘PartiaiAndNonCoherent’, and ‘NonCoherent’, respectively.

TABLE 2
Precoding information and number of layers for 4 antenna ports, if
transform precoder is enabled, or if transform precoder is disabled and ul-
FullPowerTransmission is either not configured or configured to fullpowerMode2, or if
transform precoder is disabled, maxRank = 1, and ul-FullPowerTransmission is not
configured or configured to fullpowerMode2 or configured to fullpower

| Bit field | | Bit field | | Bit field | |
|---|---|---|---|---|---|
| mapped | codebookSubset = | mapped | codebookSubset = | mapped | codebookSubset = |
| to index | fullyAndPartialAndNonCoherent | to index | partialAndNonCoherent | to index | nonCoherent |
| 0 | 1 layer: TPMI = 0 | 0 | 1 layer: TPMI = 0 | 0 | 1 layer: TPMI = 0 |
| 1 | 1 layer: TPMI = 1 | 1 | 1 layer: TPMI = 1 | 1 | 1 layer: TPMI = 1 |
| . . . | . . . | . . . | . . . | . . . | . . . |
| 3 | 1 layer: TPMI = 3 | 3 | 1 layer: TPMI = 3 | 3 | 1 layer: TPMI = 3 |
| 4 | 1 layer: TPMI = 4 | 4 | 1 layer: TPMI = 4 | | |
| . . . | . . . | . . . | . . . | | |
| 11 | 1 layer: TPMI = 11 | 11 | 1 layer: TPMI = 11 | | |
| 12 | 1 layers: TPMI = 12 | 12-15 | reserved | | |
| . . . | . . . | | | | |
| 27 | 1 layers: TPMI = 27 | | | | |
| 28-31 | reserved | | | | |

2 or 4 bits according to Table 3 for 2 antenna ports, according to whether transform precoder is enabled or disabled, and the values of higher layer parameters maxRank and codebookSubset. That is, ‘Precoding information and number of layers’ field size takes on values of 4 and 2 bits if codebookSubset is set to ‘fullyAndPartialAndNonCoherent’ and ‘NonCoherent’, respectively.

TABLE 3
Precoding information and number of layers, for 2 antenna
ports, if transform precoder is disabled, maxRank = 2,
and ul-FullPowerTransmission is not configured or
configured to fullpowerMode2 or configured to fullpower

| Bit field | codebookSubset = | Bit field | |
|---|---|---|---|
| mapped | fully | mapped | codebookSubset = |
| to index | AndPartialAndNonCoherent | to index | nonCoherent |
| 0 | 1 layer: TPMI = 0 | 0 | 1 layer: TPMI = 0 |
| 1 | 1 layer: TPMI = 1 | 1 | 1 layer: TPMI = 1 |
| 2 | 2 layers: TPMI = 0 | 2 | 2 layers: TPMI = 0 |
| 3 | 1 layer: TPMI = 2 | 3 | reserved |
| 4 | 1 layer: TPMI = 3 | | |
| 5 | 1 layer: TPMI = 4 | | |
| 6 | 1 layer: TPMI = 5 | | |
| 7 | 2 layers: TPMI = 1 | | |
| 8 | 2 layers: TPMI = 2 | | |
| 9-15 | reserved | | |

1 or 3 bits according to Table 4 for 2 antenna ports, if txConfig=codebook, and according to whether transform precoder is enabled or disabled, and the values of higher layer parameters maxRankand codebookSubset. That is, ‘Precoding information and number of layers’ field size takes on values of 3 and 1 bits if codebookSubsetis set to ‘fullyAndPartia/AndNonCoherent’ and ‘NonCoherent’;

TABLE 4
Precoding information and number of layers, for 2 antenna
ports, if transform precoder is enabled
and ul-FullPowerTransmission is not configured or configured to
fullpowerMode2 or configured to fullpower, or if transform precoder
is disabled, maxRank = 1, and ul-FullPowerTransmission is not
configured or configured to fullpowerMode2 or configured to fullpower

| Bit field | | Bit field | |
|---|---|---|---|
| mapped | codebookSubset = | mapped | codebookSubset = |
| to index | fullyAndPartialAndNonCoherent | to index | nonCoherent |
| 0 | 1 layer: TPMI = 0 | 0 | 1 layer: TPMI = 0 |
| 1 | 1 layer: TPMI = 1 | 1 | 1 layer: TPMI = 1 |
| 2 | 1 layer: TPMI = 2 | | |
| 3 | 1 layer: TPMI = 3 | | |
| 4 | 1 layer: TPMI = 4 | | |
| 5 | 1 layer: TPMI = 5 | | |
| 6-7 | reserved | | |

the UE may perform PUSCH transmission using the TPMI and number of layers indicated. If one SRS resource is configured in the SRS resource set associated with the higher layer parameter usage of value ‘CodeBook’ then the PUSCH DMRS may be spatially related to the most recent SRS transmission in this SRS resource. If two SRS resources are configured in the SRS resource set associated with the higher layer parameter usage of value ‘CodeBook’ then the PUSCH DMRS is spatially related to the most recent SRS transmission in the SRS resource indicated by the ‘SRS resource indicator’ field.

The TPMI may be used to indicate the precoder to be applied over the layers {0 . . . v−1} and that corresponds to the SRS resource selected by the SRI when multiple SRS resources are configured, or if a single SRS resource is configured TPMI is used to indicate the precoder to be applied over the layers {0 . . . v−1} and that corresponds to the SRS resource. The transmission precoder may be selected from the uplink codebook that has a number of antenna ports equal to higher layer parameter nrofSRS-Ports in SRS-Config. Please note that, in some embodiments where N_{SRS}=1 and txConfig=Codebook, an SRI field in a DCI message that schedules a PUSCH for a UE may have 0 bits. In such a case, the only SRS resource configured at the UE can still be considered as being indicated by the DCI message implicitly, and therefore the DCI message always indicates, to the UE, at least one SRS resource. Non-Codebook based UL transmission is available in NR, enabling reciprocity-based UL transmission. By assigning a DL CSI-RS to the UE, the UE may measure and deduce suitable precoder weights for PUSCH transmission of up to four spatial layers. The candidate precoder weights may be used to precode up to four single-port SRSs, and each precoded single-port SRS may be transmitted in an SRS resource. Each single-port SRS corresponds to a single PUSCH layer. Subsequently, the gNB may indicate the transmission rank and multiple SRS resource indicators, jointly encoded using

$$⌈ {log}_{2} ( {\sum }_{k = 1}^{min \{ {L}_{max} , {N}_{SRS} \}} ( \begin{matrix}{N}_{SRS} \\ k\end{matrix} ) ) ⌉ bits ,$$

where N_{SRS} indicates the number of configured SRS resources, and Lₘₐₓ is the maximum number of supported layers for PUSCH. Non-Codebook based PUSCH in NR is enabled if higher layer parameter txConfig=noncodebook. Table 5 shows the mapping of codepoints of the SRI field to SRI(s) for different number of N_{SRS} when Lₘₐₓ=4.

TABLE 5
SRI indication for non-codebook based PUSCH transmission,
Lₘₐₓ = 4

| Bit field | SRI(s), | Bit field | SRI(s), | Bit field | SRI(s), |
|---|---|---|---|---|---|
| mapped to | N_{SRS} = | mapped to | N_{SRS} = | mapped to | N_{SRS} = |
| index | 2 | index | 3 | index | 4 |
| 0 | 0 | 0 | 0 | 0 | 0 |
| 1 | 1 | 1 | 1 | 1 | 1 |
| 2 | 0, 1 | 2 | 2 | 2 | 2 |
| 3 | reserved | 3 | 0, 1 | 3 | 3 |
| | | 4 | 0, 2 | 4 | 0, 1 |
| | | 5 | 1, 2 | 5 | 0, 2 |
| | | 6 | 0, 1, 2 | 6 | 0, 3 |
| | | 7 | reserved | 7 | 1, 2 |
| | | | | 8 | 1, 3 |
| | | | | 9 | 2, 3 |
| | | | | 10 | 0, 1, 2 |
| | | | | 11 | 0, 1, 3 |
| | | | | 12 | 0, 2, 3 |
| | | | | 13 | 1, 2, 3 |
| | | | | 14 | 0, 1, 2, 3 |
| | | | | 15 | reserved |

Note that in NR Rel-15/16, the number of SRS resource sets with higher layer parameter usage set to ‘nonCodeBook’ may be limited to one (i.e., only one SRS resource set is allowed to be configured for the purposes of non-Codebook based PUSCH transmission). The maximum number of SRS resources that can be configured for non-codebook based uplink transmission is 4.

In NR, for non-codebook based PUSCH, the UE may perform a one-to-one mapping from the indicated SRI(s) to the indicated DM-RS port(s) and their corresponding PUSCH layers {0 . . . v−1} in an increasing order. The UE may transmit PUSCH using the same antenna ports as the SRS port(s) in the SRS resource(s) indicated by SRI(s), where the SRS port in (i+1)^{th} SRS resource in the SRS resource set is indexed as pᵢ=1000+i.

With regards to Non-codebook based PUSCH, the following is specified in 3GPP TS 38.214 V16.6.0:

For non-codebook based transmission, the UE can calculate the precoder used for the transmission of SRS based on measurement of an associated Non-Zero Power (NZP) CSI-RS resource. A UE can be configured with only one NZP CSI-RS resource for the SRS resource set with higher layer parameter usage in SRS-ResourceSet set to ‘nonCodebook’ if configured.

Hence, for non-codebook based PUSCH transmission, only one NZP CSI-RS resource is configured in the SRS resource set, and the UE can calculate the precoder used for the transmission of SRS using this associated NZP CSI-RS resource. The single NZP CSI-RS resource configured per SRS resource set may be part of the SRS-Config information element and is shown below. The condition ‘NonCodebook’ may mean that the associated NZP CSI-RS is optionally present in case of the SRS resource set configured with usage set to ‘nonCodeBook’ otherwise the field is absent.

### SRS-Config Information Element

-- ASN1START
-- TAG-SRS-CONFIG-START
...

| | |
|---|---|
| SRS-ResourceSet ::= | SEQUENCE { |
| srs-ResourceSetId | SRS-ResourceSetId, |
| srs-ResourceIdList | SEQUENCE (SIZE(1..maxNrofSRS-ResourcesPerSet)) OF |
| SRS-ResourceId | OPTIONAL, -- Cond Setup |
| resourceType | CHOICE { |
| aperiodic | SEQUENCE { |
| aperiodicSRS-ResourceTrigger | INTEGER (1..maxNrofSRS-TriggerStates−1), |
| csi-RS | NZP-CSI-RS-ResourceId |

OPTIONAL, -- Cond NonCodebook

| | |
|---|---|
| slotOffset | INTEGER (1..32) |

```
OPTIONAL, -- Need S
      ...,
      [[
```

| | |
|---|---|
| aperiodicSRS-ResourceTriggerList | SEQUENCE (SIZE(1..maxNrofSRS- |

TriggerStates−2))

| | |
|---|---|
| | OF INTEGER (1..maxNrofSRS- |
| TriggerStates−1) | OPTIONAL -- Need M |

```
      ]]
    },
```

| | |
|---|---|
| semi-persistent | SEQUENCE { |
| associatedCSI-RS | NZP-CSI-RS-ResourceId |

```
OPTIONAL, -- Cond NonCodebook
      ...
    },
```

| | |
|---|---|
| periodic | SEQUENCE { |
| associatedCSI-RS | NZP-CSI-RS-ResourceId |

```
OPTIONAL, -- Cond NonCodebook
      ...
    }
  },
```

| | |
|---|---|
| usage | ENUMERATED {beamManagement, codebook, nonCodebook, |

antennaSwitching},

| | |
|---|---|
| alpha | Alpha |

OPTIONAL, -- Need S

| | |
|---|---|
| p0 | INTEGER (−202..24) |

OPTIONAL, -- Cond Setup

| | |
|---|---|
| pathlossReferenceRS | CHOICE { |
| ssb-Index | SSB-Index, |
| csi-RS-Index | NZP-CSI-RS-ResourceId |

}

| | |
|---|---|
| srs-PowerControlAdjustmentStates | ENUMERATED { sameAsFci2, separateClosedLoop} |

OPTIONAL, -- Need S
...
}

| | |
|---|---|
| SRS-ResourceSetId ::= | INTEGER (0..maxNrofSRS-ResourceSets−1) |

}
-- TAG-SRS-CONFIG-STOP
-- ASN1STOP

It is further specified in 3GPP TS 38.214 that if the UE is configured with an SRS resource set with an associated NZP CSI-RS resource, then the UE is not expected to be configured with spatial relation information in any of the SRS resources in the SRS resource set.

UCI on PUSCH can be ACK/NACK or CSI in the following ways, where different types of HARQ codebooks are defined in section 9.1 of 38.213 V16.6.0, the DAI (downlink assignment index) is defined in the DCI format in 38.212 V16.6.0:
ACK/NACK with more than 2 bits and other UCI are rate matched, ACK/NACK with 1-2 bits is mapped via puncturing PUSCH data or CSI bits
Due to code-block-group-based HARQ feedback, ACK/NACK size can be very large in NR→Puncturing large ACK/NACK into PUSCH leads to severe PUSCH performance degradation
DAI mechanism similar to LTE is used to indicate number of ACK/NACK bits for UCI on PUSCH
   DCI format 0_1 contains 1 bit UL DAI for fixed HARQ codebook, 2 bit UL DAI for dynamic HARQ codebook, and 2 bit UL DAI for dynamic HARQ codebook together with CBG configuration (one DAI for each sub-codebook)
   DCI format 0_0 does not contain any DAI
CSI can be split into two parts
Semi-statically configured and dynamically indicated beta values are supported
   Individual beta values can be set for ACK/NACK and CSI
   For dynamically indicated beta values, 2 bits in DCI format 0_1 select one value for ACK/NACK and CSI (n^{th} row in ACK/NACK and CSI table)

Principles of UCI mapping on PUSCH
CSI Part 1
   For rate matched ACK/NACK, CSI Part 1 is mapped from first available non-DM-RS symbol, mapping around ACK/NACK REs
   For puncturing ACK/NACK, CSI Part 1 is mapped from first available non-DM-RS symbol, mapping around those REs reserved for ACK/NACK puncturing (PUSCH and CSI Part 2 can be mapped on reserved resources, but will eventually be punctured)
CSI part 2 is mapped from first available non-DM-RS symbol, following CSI Part 1
   For puncturing ACK/NACK, CSI Part 2 can be mapped on resources reserved for ACK/NACK (and will then be punctured by ACK/NACK)
UCI is not FDMed (frequency division multiplexed) with DM-RS
Generally the following frequency-domain mapping procedure for all UCI types is used: Fill up symbol(s) completely with modulations symbols of one UCI type (if enough UCI modulation symbols are available); This is followed by one symbol where remaining UCI modulation symbols of this type are mapped on a comb across PUSCH bandwidth.

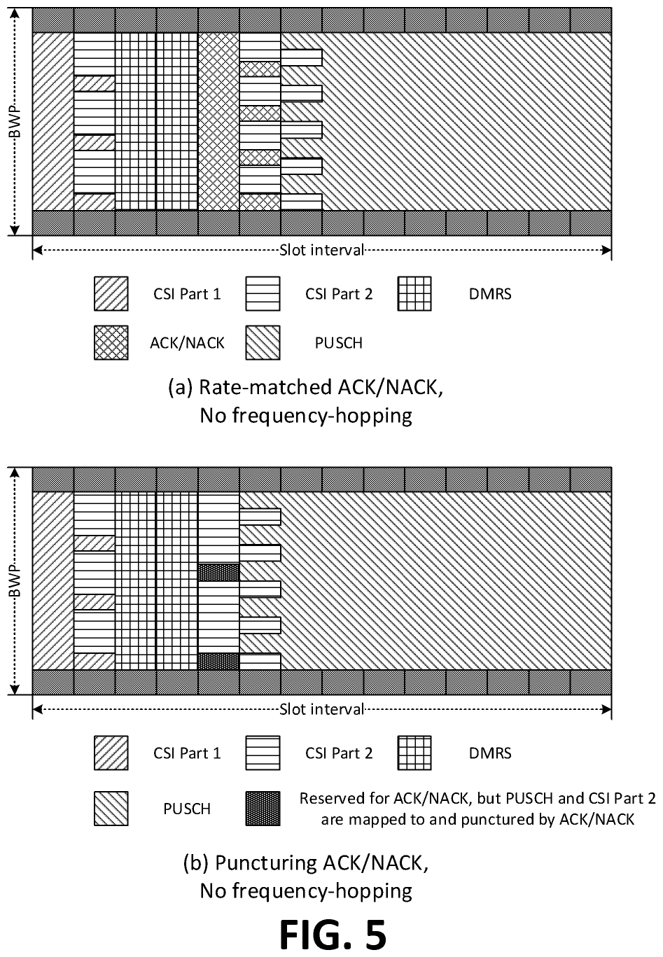

FIG. 5 is a diagram illustrating exemplary multiplexing of UCI on PUSCH that is applicable to a UE and gNB according to an embodiment of the present disclosure. As shown in FIG. 5, an example where ACK/NACK is rate matched around is shown in (a) and another example where ACK/NACK is mapped via puncturing PUSCH data or CSI bits is shown in (b).

From 3GPP TS 38.213 v16.6.0:

If a UE transmits a PUSCH over multiple slots and the UE would transmit a PUCCH with HARQ-ACK and/or CSI information over a single slot that overlaps with the PUSCH transmission in one or more slots of the multiple slots, and the PUSCH transmission in the one or more slots fulfills the conditions in cause 9.2.5 for multiplexing the HARQ-ACK and/or CSI information, the UE multiplexes the HARQ-ACK and/or CSI information in the PUSCH transmission in the one or more slots. The UE does not multiplex HARQ-ACK and/or CSI information in the PUSCH transmission in a slot from the multiple slots if the UE would not transmit a single-slot PUCCH with HARQ-ACK and/or CSI information in the slot in case the PUSCH transmission was absent

The following is captured in 3GPP TS 38.212 v16.6.0 with regards to rate matching, where the beta offset values are defined for a UE to determine a number of resources for multiplexing HARQ-ACK information and for multiplexing CSI reports in a PUSCH with details defined in section 9.3 of 38.213 V16.6.0:

```
6.3.2.4 Rate matching
6.3.2.4.1 UCI encoded by Polar code
6.3.2.4.1.1 HARQ-ACK
For HARQ-ACK transmission on PUSCH with UL-SCH, the number of coded modulation symbols per
layer for HARQ-ACK transmission, denoted as Q′_{ACK} , is determined as follows:
${Q}_{A C K}^{′} = min \{ ⌈ \frac{( {O}_{A C K} + {L}_{A C K} ) \cdot {β}_{offset}^{PUSCH} \cdot {\sum }_{l = 0}^{{N}_{symb , all}^{PUSCH} - 1} {M}_{s c}^{UCI} ( l )}{{\sum }_{r = 0}^{{C}_{UL - SCH} - 1} {K}_{r}} ⌉ , ⌈ α \cdot {\sum }_{l = {l}_{0}}^{{N}_{symb , all}^{PUSCH} - 1} {M}_{s c}^{UCI} ( l ) ⌉ \}$
where
  - O_{ACK} is the number of HARQ-ACK bits;
  - if O_{ACK} ≥ 360, L_{ACK} = 11; otherwise L_{ACK} is the number of CRC bits for HARQ-ACK determined
    according to Clause 6.3.1.2.1 of 3GPP TS 38.212 v16.6.0;
  - β_{offset}^{PUSCH} = β_{offset}^{HARQ-ACK};
  - C_{UL-SCH} is the number of code blocks for UL-SCH of the PUSCH transmission;
  - if the DCI format scheduling the PUSCH transmission includes a CBGTI field indicating that the UE shall
    not transmit the ᵣ-th code block, Kᵣ =0; otherwise, Kᵣ is the ᵣ-th code block size for UL-SCH of the
    PUSCH transmission;
  - M_{sc}^{PUSCH} is the scheduled bandwidth of the PUSCH transmission, expressed as a number of subcarriers;
  - M_{sc}^{PT-RS} (l) is the number of subcarriers in OFDM symbol l that carries PTRS, in the PUSCH transmission;
  - M_{sc}^{UCI} (l) is the number of resource elements that can be used for transmission of UCI in OFDM symbol l,
    for l = 0, 1, 2, ..., N_{symb, all}^{PUSCH} −1 , in the PUSCH transmission and N_{symb, all}^{PUSCH} is the total number of
    OFDM symbols of the PUSCH, including all OFDM symbols used for DMRS;
    - for any OFDM symbol that carries DMRS of the PUSCH, M_{sc}^{UCI} (l) = 0 ;
    - for any OFDM symbol that does not carry DMRS of the PUSCH, M_{sc}^{UCI}(l) = M_{sc}^{PUSCH} − M_{sc}^{PT-RS} (l);
  - ₐ is configured by higher layer parameter scaling;
  - l is the symbol index of the first OFDM symbol that does not carry DMRS of the PUSCH, after the first
    DMRS symbol(s), in the PUSCH transmission.
For HARQ-ACK transmission on PUSCH without UL-SCH, the number of coded modulation symbols
per layer for HARQ-ACK transmission, denoted as Q′_{ACK}, is determined as follows:
${Q}_{A C K}^{′} = min \{ ⌈ \frac{( {O}_{A C K} + {L}_{A C K} ) \cdot {β}_{offset}^{P U S C H}}{R \cdot {Q}_{m}} ⌉ , ⌈ α \cdot {\sum }_{l = {l}_{0}}^{{N}_{symb , all}^{PUSCH} - 1} {M}_{s c}^{U C I} ( l ) ⌉ \}$
where
  - O_{ACK} is the number of HARQ-ACK bits;
  - if O_{ACK} ≥ 360, L_{ACK} = 11; otherwise L_{ACK} is the number of CRC bits for HARQ-ACK defined according
    to Clause 6.3.1.2.1 ;;
  - β_{offset}^{PUSCH} = β_{offset}^{HARQ-ACK};
  - M_{sc}^{PUSCH} is the scheduled bandwidth of the PUSCH transmission, expressed as a number of subcarriers;
  - M_{sc}^{PT-RS} (l) is the number of subcarriers in OFDM symbol l that carries PTRS, in the PUSCH transmission;
  - M_{sc}^{UCI} (l) is the number of resource elements that can be used for transmission of UCI in OFDM symbol l,
    for l = 0, 1, 2, ..., N_{symb, all}^{PUSCH} −1 , in the PUSCH transmission and N_{symb, all}^{PUSCH} is the total number of
    OFDM symbols of the PUSCH, including all OFDM symbols used for DMRS;
    - for any OFDM symbol that carries DMRS of the PUSCH, M_{sc}^{UCI} (l) = 0 ;
    - for any OFDM symbol that does not carry DMRS of the PUSCH, M_{sc}^{UCI} (l) = M_{sc}^{PUSCH} − M_{sc}^{PT-RS} (l);
  - l is the symbol index of the first OFDM symbol that does not carry DMRS of the PUSCH, after the first
    DMRS symbol(s), in the PUSCH transmission;
  - ₐ is the code rate of the PUSCH, determined according to Clause 6.1.4.1 of [6, TS38.214];
  - Qₘ is the modulation order of the PUSCH;
  - ₐ is configured by higher layer parameter scaling.
```

Further, in NR R16, PHY prioritization between UL transmissions of different PHY priority index is introduced in 3GPP to address resource conflicts between DG PUSCH and CG PUSCH and conflicts involving multiple CGs and also to address UL data/control and control/control resource collision.

Rel-16 supports a two-level PHY priority index indication of:
Scheduling Request (SR): SR configuration may have a PHY priority index indication as an RRC field in SR resource configuration.
   Note: PHY priority index is only used to let PHY know the priority. MAC will perform prioritization based on Logical Channel (LCH) priorities.
HARQ-ACK: PHY priority index may be indicated in DL DCI (Formats 1_1 and 1_2) for dynamic assignments and for CG PUSCH the PHY priority index may be indicated by RRC configuration.
PUSCH: For DG PUSCH, PHY priority index may be indicated in UL DCI (Formats 0_1 and 0_2), and for CG PUSCH, the PHY priority index may be indicated by CG PUSCH configuration.
A-periodic and semi-persistent CSI on PUSCH: PHY priority index may be indicated in UL DCI (Formats 0_1 and 0_2).
Low PHY priority index is assumed for periodic and semi-persistent CSI on PUCCH, periodic and semi-persistent SRS and when PHY priority index is not indicated.
Aperiodic SRS is always of low priority.

PHY priority index 0 may be defined as low priority and PHY priority index 1 is defined as high priority.

In Rel-16, UCI may be multiplexed in a PUCCH or a PUSCH only if PHY priority index of UCI and the PHY priority index of PUCCH or PUSCH are the same. Certain combinations of multiplexing UCI and PUSCH of different priorities are expected to be supported in Rel-17, for example, multiplexing a high-priority HARQ-ACK and a low-priority HARQ-ACK into a PUCCH, multiplexing a low-priority HARQ-ACK in a high-priority PUSCH, etc.

The Rel-16 intra-UE PHY prioritization first resolves time-overlapping for PUCCH and/or PUSCH transmissions for same PHY priority, then time-overlapping between priorities is resolved, where the lower-priority PUCCH/PUSCH is not transmitted if it is time-overlapping with a higher-priority PUCCH/PUSCH transmission. Here, it should be emphasized that UE does not resolve time-overlapping for PUCCH/PUSCH transmissions of high-priority before resolving time-overlapping between priorities. This means that UE will cancel a low-priority PUCCH/PUSCH transmission that time-overlaps with a high-priority PUCCH but not with a high-priority PUSCH that time-overlaps with the high-priority PUCCH although the high-priority PUCCH will not be sent since UCI would be multiplexed on the high-priority PUSCH.

Rel-16 also supports 2 HARQ codebooks and both can be slot/sub-slot based or can be different (Each codebook is separately configured).
Two HARQ-ACK CodeBooks (CBs) can be configured
   1st HARQ-ACK CB H PHY priority index 0
   2nd HARQ-ACK CB H PHY priority index 1
Two PUCCH configurations
   1st PUCCH H 1st HARQ-ACK CB
   2nd PUCCH H 2nd HARQ-ACK CB
   Each PUCCH can be slot or sub-slot configured
Two UCI-OnPUSCH (one per HARQ-ACK codebook)
   i.e., Beta-factor for HARQ-ACK (and CSI) per PHY priority index

Further, in NR up to Release 17, 2 codewords are supported for PDSCH transmission and only single codeword is supported for PUSCH transmission. Up to 4 transmission layers are supported in uplink while up to 8 transmission layers are supported in downlink. When 2 codewords are used in downlink, the number of transmission layers shall be greater than 4. When the number of transmission layers is less than or equal to 4, a single codeword may be used in the downlink in NR up to Rel-17. The codeword to layer mapping assumed in NR is shown in Table 6.

TABLE 6
Codeword-to-layer mapping for spatial multiplexing.

| Number | Number | | |
|---|---|---|---|
| of | of | Codeword-to-layer mapping | |
| layers | codewords | i = 0, 1, . . . , M_{symb}^{layer} − 1 | |
| 1 | 1 | x⁽⁰⁾(i) = d⁽⁰⁾(i) | M_{symb}^{layer} = M_{symb}⁽⁰⁾ |
| 2 | 1 | x⁽⁰⁾(i) = d⁽⁰⁾(2i) | M_{symb}^{layer} = M_{symb}⁽⁰⁾/2 |
| | | x⁽¹⁾(i) = d⁽⁰⁾(2i + 1) | |
| 3 | 1 | x⁽⁰⁾(i) = d⁽⁰⁾(3i) | M_{symb}^{layer} = M_{symb}⁽⁰⁾/3 |
| | | x⁽¹⁾(i) = d⁽⁰⁾(3i + 1) | |
| | | x⁽²⁾(i) = d⁽⁰⁾(3i + 2) | |
| 4 | 1 | x⁽⁰⁾(i) = d⁽⁰⁾(4i) | M_{symb}^{layer} = M_{symb}⁽⁰⁾/4 |
| | | x⁽¹⁾(i) = d⁽⁰⁾(4i + 1) | |
| | | x⁽²⁾(i) = d⁽⁰⁾(4i + 2) | |
| | | x⁽³⁾(i) = d⁽⁰⁾(4i + 3) | |
| 5 | 2 | x⁽⁰⁾(i) = d⁽⁰⁾(2i) | M_{symb}^{layer} = |
| | | x⁽¹⁾(i) = d⁽⁰⁾(2i + 1) | M_{symb}⁽⁰⁾/2 = |
| | | x⁽²⁾(i) = d⁽¹⁾(3i) | M_{symb}⁽¹⁾/3 |
| | | x⁽³⁾(i) = d⁽¹⁾(3i + 1) | |
| 6 | 2 | x⁽⁰⁾(i) = d⁽⁰⁾(3i) | M_{symb}^{layer} = |
| | | x⁽¹⁾(i) = d⁽⁰⁾(3i + 1) | M_{symb}⁽⁰⁾/3 = |
| | | x⁽²⁾(i) = d⁽⁰⁾(3i + 2) | M_{symb}⁽¹⁾/3 |
| | | x⁽³⁾(i) = d⁽¹⁾(3i) | |
| | | x⁽⁴⁾(i) = d⁽¹⁾(3i + 1) | |
| | | x⁽⁵⁾(i) = d0)(3i + 2) | |
| 7 | 2 | x⁽⁰⁾(i) = d⁽⁰⁾(3i) | M_{symb}^{layer} = |
| | | x⁽¹⁾(i) = d⁽⁰⁾(3i + 1) | M_{symb}⁽⁰⁾/3 = |
| | | x⁽²⁾(i) = d⁽⁰⁾(3i + 2) | M_{symb}⁽¹⁾/4 |
| | | x⁽³⁾(i) = d⁽¹⁾(4i) | |
| | | x⁽⁴⁾(i) = d⁽¹⁾(4i + 1) | |
| | | x⁽⁵⁾(i) = d⁽¹⁾(4i + 2) | |
| | | x⁽⁶⁾(i) = d⁽¹⁾(4i + 3) | |
| 8 | 2 | x⁽⁰⁾(i) = d⁽⁰⁾(4i) | M_{symb}^{layer} = |
| | | x⁽¹⁾(i) = d⁽⁰⁾(4i + 1) | M_{symb}⁽⁰⁾/4 = |
| | | x⁽²⁾(i) = d⁽⁰⁾(4i + 2) | M_{symb}⁽¹⁾/4 |
| | | x⁽³⁾(i) = d⁽⁰⁾(4i + 3) | |
| | | x⁽⁴⁾(i) = d⁽¹⁾(4i) | |
| | | x⁽⁵⁾(i) = d⁽¹⁾(4i + 1) | |
| | | x⁽⁶⁾(i) = d⁽¹⁾(4i + 2) | |
| | | x⁽⁷⁾(i) = d⁽¹⁾(4i + 3) | |

Further, in NR Release 16, PUSCH repetition enhancements were made for both PUSCH type A and type B for the purposes of further latency reduction (i.e., for Rel-16 URLLC feature).

In NR Rel-15, the number of aggregated slots for both dynamic grant and configured grant Type 2 may be RRC configured. In NR Rel-16, this was enhanced so that the number of repetitions can be dynamically indicated, i.e. the number of repetitions can be changed from one PUSCH scheduling occasion to the next via DCI indication. That is, in addition to the starting symbol S, and the length of the PUSCH L, a number of nominal repetitions K is signaled as part of time-domain resource allocation (TDRA). Furthermore, the maximum number of aggregated slots was increased to K=16 to account for DL heavy Time Division Duplex (TDD) patterns. Inter-slot and intra-slot hopping can be applied for PUSCH repetition Type A. The number of repetitions K is nominal since some slots may be DL slots and the DL slots are then skipped for PUSCH transmissions. So, K is the maximal number of repetitions possible.

PUSCH repetition Type B applies to both dynamic and configured grants. Type B PUSCH repetition can cross the slot boundary in NR Rel-16. When scheduling a transmission with PUSCH repetition Type B, in addition to the starting symbol S, and the length of the PUSCH L, a number of nominal repetitions K is signaled as part of time-domain resource allocation (TDRA) in NR Rel-16. Inter-slot frequency hopping and inter-repetition frequency hopping can be configured for Type B repetition. To determine the actual time domain allocation of Type B PUSCH repetitions, a two-step process is used:
Allocate K nominal repetitions of length L back-to-back (adjacent in time), ignoring slot boundaries and TDD pattern.
If a nominal repetition crosses a slot boundary or occupies symbols not usable for UL transmission (e.g. UL/DL switching points due to TDD pattern), the offending nominal repetition may be split into two or more shorter actual repetitions. If the number of potentially valid symbols for PUSCH repetition type B transmission is greater than zero for a nominal repetition, the nominal repetition consists of one or more actual repetitions, where each actual repetition consists of a consecutive set of potentially valid symbols that can be used for PUSCH repetition Type B transmission within a slot.

Although the term ‘PUSCH repetition’ is used in this document, it can be interchangeably used with other terms such as ‘PUSCH transmission occasion’.

In NR Rel-15/16, when PUSCH is repeated according to PUSCH repetition Type A, the PUSCH is limited to a single transmission layer.

In Rel-15, slot aggregation, also known as PUSCH repetition Type A in Rel-16, has been supported, where number of slot-based PUSCH repetitions is semi-statically configured. In Rel-16, the number of PUSCH repetitions can be dynamically indicated with DCI.

In Rel-15/16, PUSCH repetition Type A allows a single repetition in each slot, with each repetition occupying the same symbols. In some TDD UL/DL configurations, there are a small number of contiguous UL slots in a radio frame. In this scenario, multiple PUSCH repetitions do not have to be in contiguous slots. However, the DL slots are counted as slots for PUSCH repetitions.

Two enhancements of PUSCH repetition Type A were agreed as part of the Rel-17 NR coverage enhancement work item (WI) in 3GPP. The agreement is given below:
PUSCH repetition Type A
   Opt.1: Increasing the maximum number of repetitions up to a number to be determined during the course of the work.
   Opt.2: The number of repetitions counted on the basis of available UL slots.

Regarding Option 2 (Opt.2), definition of available slot was discussed in 3GPP. Determination of available slot is still being discussed in 3GPP RAN1.

In NR, only one codeword (or one transport block) up to 4 layers can be used for transmission on PUSCH scheduled by dynamic grant or configured grant. In non-codebook based PUSCH transmission, all possible numbers of layers and the corresponding SRS resources indicated are defined in SRI indication tables.

When the number of supported layers is increased to be greater than four, the number of rows of the tables will also need to be increased. For example, when up to 8 layers are supported, the number of rows required may be up to 256 rows which will result in a large DCI overhead. Hence, how to support more than four PUSCH layers for non-codebook based PUSCH with reduced DCI overhead is an open problem.

Further, for codebook based PUSCH transmission, when more than 4 layers are supported, the number of antenna ports configured per SRS resource should also be extended from “up to 4” to “up to 8”.

For CG Type 1 PUSCH transmission, the SRI indication cannot be provided in DCI and some additional higher layer signaling is needed to indicate the SRS resource among a set of resources with up to more than 4 resources.

Some embodiments of the present disclosure provide methods on how to support more than 4 layer transmission for PUSCH transmission in NR with reduced DCI signaling overhead and SRS resource indication table size. Some embodiments of the present disclosure provide an SRI report design for non-codebook based PUSCH transmission. Some embodiments of the present disclosure provide an SRI report design for codebook based PUSCH transmission. Some embodiments of the present disclosure provide an SRI report for the case of CG Type 1 PUSCH transmission.

With the above embodiments, methods on how to support more than 4 layer transmission for PUSCH transmission in NR with reduced DCI signaling overhead and SRS resource indication table size may be provided.

In some embodiments, the term “DG PUSCH” may refer to the dynamic grant scheduled PUSCH, where a PUSCH transmission is scheduled by a corresponding UL scheduling DCI. In some embodiments, the term “CG PUSCH” may refer to the PUSCH scheduled by configured grant, where a PUSCH is transmitted without a corresponding UL scheduling DCI, after the configured grant configuration is activated.

In some embodiments, when the number of layers is increased from 4 layers to more than 4 layers, N_{SRS}, the number of configured SRS resources in the SRS resource set (configured by higher layer parameter srs-ResourceSetToAddModList) with usage parameter set to ‘nonCodeBook’ could be greater than 4 and the number of SRI(s) indicated in a codepoint of the ‘SRS Resource Indicator’ field may also be greater than 4.

Non-codebook based PUSCH transmission is based on an assumption of channel reciprocity, i.e., that the UE may acquire detailed knowledge of the UL channel based on DL measurements (e.g. calibrated UEs and TDD). There are no restrictions on the UE selection of precoder.

A CSI-RS may be indicated to UE for assisting calculating UL precoder using DL-UL reciprocity. By observing the DL CSI-RS, the UE can measure and deduce suitable precoder weights for PUSCH transmission of up to eight spatial layers. Then the UE may transmit up to e.g. 8 single-port SRSs in 8 SRS resources. Each SRS resource may have a single SRS port and the single port SRS transmitted in each SRS resource may correspond to a single PUSCH transmission layer. Then the gNB may indicate to the one or more SRS resources via the SRS resource indicators (SRI) field in the UL scheduling DCI.

To minimize the signaling overhead while keeping the flexibility of SRI indication to the UE in case of non-codebook based PUSCH transmission, following embodiments may be provided.

In some embodiments, only a subset of combinations of a number of indicated SRIs from the configured number of SRS resources may be considered to support more than 4 SRS resources that are configured in a SRS resource set for non-codebook based PUSCH.

In other words, the number of combinations for choosing X SRI out of e.g. 8 SRS resources may be limited to Y, where the Y values for X=1, 2, 3, . . . , 7, could be a subset of the possible values. As an example, when the number of SRS resources configured in the SRS resource set for non-Codebook based PUSCH is increased from 4 up to 8, and if the maximum number of layers Lₘₐₓ=2, some of the combinations of selecting 2 SRIs out of the configured N_{SRS}=5, 6, 7, or 8 SRS resources could be reduced in a way shown in Table 7 below which is updated based on Table 7.3.1.1.2-29 in 3GPP TS 38.212 V16.6.0. Hereinafter, the term “existing SRI indication table in 3GPP NR Rel-16” may refer to one or more SRI indication tables defined in 3GPP NR Rel-16, for example, those defined in 3GPP TS 38.212 V16.6.0 (e.g., the tables 7.3.1.1.2-28/29/30/31).

TABLE 7
SRI indication for non-codebook based PUSCH transmission, Lₘₐₓ = 2

| Bit field | | Bit field | | Bit field | |
|---|---|---|---|---|---|
| mapped | SRI(s), | mapped | SRI(s), | mapped | SRI(s), |
| to index | N_{SRS} = 2 | to index | N_{SRS} = 3 | to index | N_{SRS} = 4 |
| 0 | 0 | 0 | 0 | 0 | 0 |
| 1 | 1 | 1 | 1 | 1 | 1 |
| 2 | 0, 1 | 2 | 2 | 2 | 2 |
| 3 | reserved | 3 | 0, 1 | 3 | 3 |
| | | 4 | 0, 2 | 4 | 0, 1 |
| | | 5 | 1, 2 | 5 | 0, 2 |
| | | 6-7 | reserved | 6 | 0, 3 |
| | | | | 7 | 1, 2 |
| | | | | 8 | 1, 3 |
| | | | | 9 | 2, 3 |
| | | | | 10-15 | reserved |

| Bit field | | Bit field | | Bit field | | Bit field | |
|---|---|---|---|---|---|---|---|
| mapped | SRI(s), | mapped | SRI(s), | mapped | SRI(s), | mapped | SRI(s), |
| to index | N_{SRS} = 5 | to index | N_{SRS} = 6 | to index | N_{SRS} = 7 | to index | N_{SRS} = 8 |
| 0 | 0 | 0 | 0 | 0 | 0 | 0 | 0 |
| 1 | 1 | 1 | 1 | 1 | 1 | 1 | 1 |
| 2 | 2 | 2 | 2 | 2 | 2 | 2 | 2 |
| 3 | 3 | 3 | 3 | 3 | 3 | 3 | 3 |
| 4 | 4 | 4 | 4 | 4 | 4 | 4 | 4 |
| 5 | 0, 2 | 5 | 5 | 5 | 5 | 5 | 5 |
| 6 | 1, 3 | 6 | 0, 3 | 6 | 6 | 6 | 6 |
| 7 | 2, 4 | 7 | 2, 5 | 7 | 0, 2 | 7 | 7 |
| | | | | 8 | 0, 4 | 8 | 0, 3 |
| | | | | 9 | 0, 6 | 9 | 0, 5 |
| | | | | 10 | 1, 3 | 10 | 1, 3 |
| | | | | 11 | 1, 5 | 11 | 1, 6 |
| | | | | 12 | 2, 4 | 12 | 2, 6 |
| | | | | 13 | 2, 6 | 13 | 3, 5 |
| | | | | 14 | 3, 5 | 14 | 4, 6 |
| | | | | 15 | 4, 6 | 15 | 5, 7 |

It can be seen that after removing some of the combinations of SRIs to support the cases when N_{SRS}=5, 6, 7, or 8, the size of the bit field “SRS resource indicator” in DCI can be reduced to be 3 bits for the cases when N_{SRS}=5 or 6, and 4 bits for the case when N_{SRS}=7 or 8.

Note that without this solution, the following would be the sizes of the bit field “SRS resource indicator” in DCI:
For choosing 2 SRIs out of N_{SRS}=8 configured SRS resources in the SRS resource set, 28 combinations are involved. For choosing 1 SRI out of N_{SRS}=8 configured SRS resources in the SRS resource set, 8 combinations are involved. Hence, there are 36 combinations in total which would require ┌log₂(36)┐=6 bits. Hence, with the above embodiment, 2 bits can be saved on the field size of “SRS resource indicator” in DCI in the case of N_{SRS}=8.
For choosing 2 SRIs out of N_{SRS}=7 configured SRS resources in the SRS resource set, 21 combinations are involved. For choosing 1 SRI out of N_{SRS}=7 configured SRS resources in the SRS resource set, 7 combinations are involved. Hence, there are 28 combinations in total which would require ┌log₂(28)┐=5 bits. Hence, with the above embodiment, 1 bit can be saved on the field size of “SRS resource indicator” in DCI in the case of N_{SRS}=7.
For choosing 2 SRIs out of N_{SRS}=6 configured SRS resources in the SRS resource set, 15 combinations are involved. For choosing 1 SRI out of N_{SRS}=6 configured SRS resources in the SRS resource set, 6 combinations are involved. Hence, there are 21 combinations in total which would require ┌log₂(21)┐=5 bits. Hence, with the above embodiment, 2 bits can be saved on the field size of “SRS resource indicator” in DCI in the case of N_{SRS}=6.
For choosing 2 SRIs out of N_{SRS}=5 configured SRS resources in the SRS resource set, 10 combinations are involved. For choosing 1 SRI out of N_{SRS}=5 configured SRS resources in the SRS resource set, 5 combinations are involved. Hence, there are 15 combinations in total which would require ┌log₂(15)┐=4 bits. Hence, with the above embodiment, 1 bit can be saved on the field size of “SRS resource indicator” in DCI in the case of N_{SRS}=5.

For another example, when the number of SRS resources configured in the SRS resource set for non-Codebook based PUSCH is increased from 4 up to 8, and if the maximum number of layers Lₘₐₓ=8, some of the combinations of selecting some numbers of SRIs out of the N_{SRS}=5, 6, 7, or 8 SRS resources could be reduced in a way shown in Table 8 which is updated based on Table 7.3.1.1.2-31 in 3GPP TS 38.212 V16.6.0.

TABLE 8
SRI indication for non-codebook based PUSCH transmission, Lₘₐₓ = 8

| Bit field | | Bit field | | Bit field | |
|---|---|---|---|---|---|
| mapped | SRI(s), | mapped | SRI(s), | mapped | SRI(s), |
| to index | N_{SRS} = 2 | to index | N_{SRS} = 3 | to index | N_{SRS} = 4 |
| 0 | 0 | 0 | 0 | 0 | 0 |
| 1 | 1 | 1 | 1 | 1 | 1 |
| 2 | 0, 1 | 2 | 2 | 2 | 2 |
| 3 | reserved | 3 | 0, 1 | 3 | 3 |
| | | 4 | 0, 2 | 4 | 0, 1 |
| | | 5 | 1, 2 | 5 | 0, 2 |
| | | 6 | 0, 1, 2 | 6 | 0, 3 |
| | | 7 | reserved | 7 | 1, 2 |
| | | | | 8 | 1, 3 |
| | | | | 9 | 2, 3 |
| | | | | 10 | 0, 1, 2 |
| | | | | 11 | 0, 1, 3 |
| | | | | 12 | 0, 2, 3 |
| | | | | 13 | 1, 2, 3 |
| | | | | 14 | 0, 1, 2, 3 |
| | | | | 15 | reserved |

| Bit field | | Bit field | | Bit field | | Bit field | |
|---|---|---|---|---|---|---|---|
| mapped | SRI(s), | mapped | SRI(s), | mapped | SRI(s), | mapped | SRI(s), |
| to index | N_{SRS} = 5 | to index | N_{SRS} = 6 | to index | N_{SRS} = 7 | to index | N_{SRS} = 8 |
| 0 | 0 | 0 | 0 | 0 | 0 | 0 | 0 |
| 1 | 1 | 1 | 1 | 1 | 1 | 1 | 1 |
| 2 | 2 | 2 | 2 | 2 | 2 | 2 | 2 |
| 3 | 3 | 3 | 3 | 3 | 3 | 3 | 3 |
| 4 | 4 | 4 | 4 | 4 | 4 | 4 | 4 |
| 5 | 0, 1 | 5 | 5 | 5 | 5 | 5 | 5 |
| 6 | 1, 2 | 6 | 0, 1 | 6 | 6 | 6 | 6 |
| 7 | 2, 3 | 7 | 2, 3 | 7 | 0, 1 | 7 | 7 |
| 8 | 2, 4 | 8 | 4, 5 | 8 | 0, 3 | 8 | 0, 1 |
| 9 | 3, 4 | 9 | 0, 1, 2 | 9 | 1, 2 | 9 | 2, 3 |
| 10 | 0, 1, 2 | 10 | 1, 2, 3 | 10 | 1, 5 | 10 | 4, 5 |
| 11 | 1, 2, 3 | 11 | 3, 4, 5 | 11 | 2, 3 | 11 | 6, 7 |
| 12 | 3, 4, 5 | 12 | 0, 1, 2, 3 | 12 | 3, 4 | 12 | 0, 1, 2 |
| 13 | 0, 1, 2, 4 | 13 | 1, 2, 3, 4 | 13 | 4, 5 | 13 | 2, 3, 4 |
| 14 | 0, 1, 2, 3 | 14 | 2, 3, 4, 5 | 14 | 5, 6 | 14 | 4, 5, 6 |
| 15 | 0, 1, 2, 3, 4 | 15 | 0, 1, 2, 3, 4, 5 | 15 | 0, 1, 2 | 15 | 0, 1, 2, 3 |
| | | | | 16 | 1, 2, 3 | 16 | 0, 2, 4, 6 |
| | | | | 17 | 2, 3, 4 | 17 | 2, 3, 4, 5 |
| | | | | 18 | 4, 5, 6 | 18 | 4, 5, 6, 7 |
| | | | | 19 | 0, 1, 2, 3 | 19 | 0, 1, 2, 3, 4 |
| | | | | 20 | 0, 2, 4, 6 | 20 | 0, 2, 4, 6, 7 |
| | | | | 21 | 1, 2, 3, 4 | 21 | 1, 2, 3, 4, 5 |
| | | | | 22 | 2, 3, 4, 5 | 22 | 1, 3, 5, 6, 7 |
| | | | | 23 | 2, 3, 4, 6 | 23 | 2, 3, 4, 5, 6 |
| | | | | 24 | 3, 4, 5, 6 | 24 | 2, 3, 4, 6, 7 |
| | | | | 25 | 0, 1, 2, 3, 4 | 25 | 3, 4, 5, 6, 7 |
| | | | | 26 | 0, 1, 2, 3, 5 | 26 | 0, 1, 2, 3, 4, 5 |
| | | | | 27 | 1, 2, 3, 4, 5 | 27 | 1, 2, 3, 4, 5, 6 |
| | | | | 28 | 2, 3, 4, 5, 6 | 28 | 2, 3, 4, 5, 6, 7 |
| | | | | 29 | 0, 1, 2, 3, 4, 5 | 29 | 0, 1, 2, 3, 4, 5, 6 |
| | | | | 30 | 1, 2, 3, 4, 5, 6 | 30 | 1, 2, 3, 4, 5, 6, 7 |
| | | | | 31 | 0, 1, 2, 3, 4, 5, 6 | 31 | 0, 1, 2, 3, 4, 5, 6, 7 |

It can be seen that after removing some of the combinations of SRIs to support the cases when N_{SRS}=5, 6, 7, or 8, the size of the bit field “SRS resource indicator” in DCI can be reduced to be 4 bits for the cases when N_{SRS}=5 or 6, and 5 bits for the case when N_{SRS}=7 or 8.

Note that without this solution, the following would be the sizes of the bit field “SRS resource indicator” in DCI:
Using existing specifications in NR, the number of bits needed in “SRS resource indicator” field for the case when Lₘₐₓ=8 and N_{SRS}=8 is

$$⌈ {log}_{2} ( {\sum }_{k = 1}^{min \{ {L}_{max} , {N}_{SRS} \}} ( \begin{matrix}{N}_{SRS} \\ k\end{matrix} ) ) ⌉ = 8 bits .$$

Hence, with the above embodiment, 3 bits can be saved on the field size of “SRS resource indicator” in DCI in the case of N_{SRS}=8.
Using existing specifications in NR, the number of bits needed in “SRS resource indicator” field for the case when Lₘₐₓ=8 and N_{SRS}=7 is

$$⌈ {log}_{2} ( {\sum }_{k = 1}^{min \{ {L}_{max} , {N}_{SRS} \}} ( \begin{matrix}{N}_{SRS} \\ k\end{matrix} ) ) ⌉ = 7 bits .$$

Hence, with the above embodiment, 3 bits can be saved on the field size of “SRS resource indicator” in DCI in the case of N_{SRS}=7.
Using existing specifications in NR, the number of bits needed in “SRS resource indicator” field for the case when Lₘₐₓ=8 and N_{SRS}=6 is

$$⌈ {log}_{2} ( {\sum }_{k = 1}^{min \{ {L}_{max} , {N}_{SRS} \}} ( \begin{matrix}{N}_{SRS} \\ k\end{matrix} ) ) ⌉ = 6 bits .$$

Hence, with the above embodiment, 4 bits can be saved on the field size of “SRS resource indicator” in DCI in the case of N_{SRS}=6.
Using existing specifications in NR, the number of bits needed in “SRS resource indicator” field for the case when Lₘₐₓ=8 and N_{SRS}=5 is

$$⌈ {log}_{2} ( {\sum }_{k = 1}^{min \{ {L}_{max} , {N}_{SRS} \}} ( \begin{matrix}{N}_{SRS} \\ k\end{matrix} ) ) ⌉ = 5 bits .$$

Hence, with the above embodiment, 4 bits can be saved on the field size of “SRS resource indicator” in DCI in the case of N_{SRS}=5.

In some embodiments, all combinations of SRI indications may be grouped into different subsets for each column of a large table, and which subset is used can be indicated by the network, e.g. via MAC CE/RRC signaling.

For example, when N_{SRS}=8 and Lₘₐₓ=8, all 255 combinations of SRI indications (since the combination of none SRS resources indicated is obviously not an option) may be grouped into 8 different subsets. Each subset then may have 32 combinations of SRI indications except for one subset having 31 combinations of SRI indications. Which subset is mapped to the codepoints of an ‘SRS Resource Indicator’ field can be indicated to the UE by MAC CE/RRC. Thereafter, one of the SRI combinations within the subset mapped to the ‘SRS Resource Indicator’ field to the UE which will be used for subsequent transmission of non-codebook based PUSCH. In this embodiment, since only 32 or 31 SRI indication combinations are involved in a subset, only 5 bits are sufficient for the ‘SRS Resource Indicator’ field in the uplink DCI.

In some embodiments, some additional SRI combination values can be added in the legacy tables (e.g., the tables described in 3GPP TS 38.212 V16.6.0 or any prior release) without extending the number of bits in the ‘SRS Resource Indicator’ field when the number of SRS resources configured in the SRS resource set for non-Codebook based PUSCH is extended beyond 4 resources.

For example, when the number of SRS resources configured in the SRS resource set for non-Codebook based PUSCH is increased from 4 to 7, and if the maximum number of layers Lₘₐₓ=2, the SRI combinations for N_{SRS}=5, 6, 7 SRS resources could be assumed as the values in brackets in the columns with N_{SRS}=5, 6, or 7, respectively, as is shown in Table 9, which is updated from the Table 7.3.1.1.2-29 in 3GPP TS 38.212 V16.6.0. Not that Lₘₐₓ is only for N_{SRS}<=4 case, for N_{SRS}>4, the underlined SRI combination in the table will be used.

TABLE 9
SRI indication for non-codebook based PUSCH transmission,
Lₘₐₓ = 2 when N_{SRS} ≤ 4

| Bit field | SRI(s), | Bit field | SRI(s), | Bit field | SRI(s), |
|---|---|---|---|---|---|
| mapped | N_{SRS} = 2 | mapped | N_{SRS} = 3 | mapped | N_{SRS} = 4 |
| to index | (or 5) | to index | (or 6) | to index | (or 7) |
| 0 | 0 or (0, 1, | 0 | 0 or (0, 1, 2, 3) | 0 | 0 or (0, 1, 2, 3) |
| | 2, 3) | | | | |
| 1 | 1 or (1, 2, | 1 | 1 or (1, 2, 3, 4) | 1 | 1 or (1, 2, 3, 4) |
| | 3, 4) | | | | |
| 2 | 0, 1 or (0, 1, | 2 | 2 or (2, 3, 4, 5) | 2 | 2 or (2, 3, 4, 5) |
| | 2, 3, 4) | | | | |
| 3 | reserved | 3 | 0, 1 or (0, 1, | 3 | 3 or (3, 4, 5, 6) |
| | | | 2, 3, 4) | | |
| | | 4 | 0, 2 or (0, 2, | 4 | 0, 1 or (0, 1, |
| | | | 3, 4, 5) | | 2, 3, 4) |
| | | 5 | 1, 2 or | 5 | 0, 2 or (0, 2, |
| | | | (0, 1, 2, 3, 4, 5) | | 4, 6, 7) |
| | | 6-7 | reserved | 6 | 0, 3 or |
| | | | | | (0, 1, 2, 3, 4, 5) |
| | | | | 7 | 1, 2 or |
| | | | | | (1, 2, 3, 4, 5, 6) |
| | | | | 8 | 1, 3 or |
| | | | | | (1, 2, 3, 4, |
| | | | | | 5, 6, 7) |
| | | | | 9 | 2, 3 or |
| | | | | | (0, 1, 2, 3, |
| | | | | | 4, 5, 6) |
| | | | | 10-15 | reserved |

In this way, the bits in the ‘SRS Resource Indicator’ field are still the same as used in legacy tables, hence there is no increase in the number of bits in the ‘SRS Resource Indicator’ field.

In some embodiments, new tables may be introduced independently from legacy tables for supporting a maximum number of layers greater than 4 or number of SRS resources configured in the SRS resource set for non-Codebook based PUSCH more than 4. Examples can be seen in the above embodiments.

In some embodiments, the SRS resources in an SRS resource set may be arranged according to some criterion. For example, the SRS resources can be arranged in an (e.g. descending) order of channel response estimated based a DL CSI-RS.

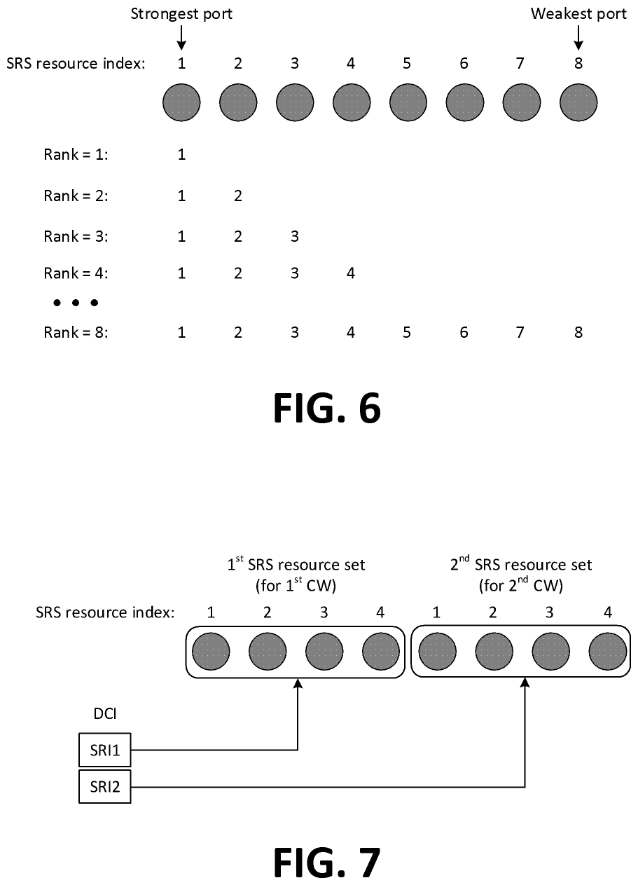

The 1^{st} SRS resource may have the best (strongest) channel response while the last SRS resource may have the least (weakest) channel response. A rank nested assumption can be used such that for rank R, the first R SRS resources may be used/indicated implicitly. An example is shown in FIG. 6, where 8 SRS resources in an SRS resource set may be ordered such that the 1^{st} SRS resource may be the strongest and the 8^{th} SRS resource may be the weakest. With this embodiment, the SRS resources may be determined by the indicated rank.

In some embodiments, a UE may be equipped with two or more antenna panels, each with up to 4 antenna ports so that legacy SRI reporting tables can be used when more than 4 SRIs are reported. For example, 2 antenna panels and two SRS resource sets may be defined, each associated with one of antenna panels. Each codeword may be associated with an SRS resource set. Two SRI fields, each associated with one SRS resource set, could be introduced in a DCI as illustrated in FIG. 7. With this embodiment, the legacy NR tables Table 7.3.1.1.2-28 to Table 7.3.1.1.2-32B in TS 38.212 v16.6.0 may be used for both the SRI fields.

In some embodiments, in case of multiple TRPs, if different numbers of layers for different TRPs are supported, the 2^{nd} SRI field may be independent from the 1^{st} SRI field for two TRPs. If more than two TRPs are supported (e.g., KTRPs), then KSRI fields may be introduced and signaled in DCI. For example, when 2 TRPs are supported for non-codebook based PUSCH transmission, the 1^{st} TRP and the 2^{nd} TRP may indicate independent SRI fields with a same number of bits in the DCI. In some embodiments, the multiple SRI fields for the multiple TRPs may only be independently configured when they have different TBs transmitted.

Codebook based PUSCH in NR is enabled if higher layer parameter txConfig=codebook. In such a case, a UE may transmit non-precoded SRS. Typically, one SRS signal is transmitted per baseband port. The UE transmits one or more SRS resources, where N_{SRS} is the number of configured SRS resources in the SRS resource set configured by higher layer parameter srs-ResourceSetToAddModList, and associated with the higher layer parameter usage of value ‘codeBook’. So far in NR, an SRS resource can be configured with 1, 2, or 4 antenna ports.

In some embodiments, the number of antenna ports can be extended to include 8 ports, so that up to 8 layers of codebook based PUSCH transmission can be supported. An SRI field in the UL scheduling DCI may select one SRS resource from the N_{SRS} SRS resources, when N_{SRS}>1. When the SRS resource of 8 port is selected, then codebook based PUSCH transmission of up to 8 layers can be supported, and two codewords may be carried by a PUSCH in the spatial domain.

In some embodiments, “SRS resource indicator”, “Precoding information and number of layers” for UL configured grant Type 1 PUSCH transmission may be provided as follows:
For Type 1 UL CG configuration(s), “SRS resource indicator”, “Precoding information and number of layers” cannot be provided by scheduling UL DCI. Instead, they may be provided by RRC parameters in configuredGrantConfig. When the maximum number of UL MIMO layers is increased to 8, then new parameters need to be introduced to signal the expanded MIMO related information.

One example of the new parameters is given below, where the SRI of Rel-18 (srs-Resourcelndicator-r18) may be added to indicate 32 possible values, assuming a table of 32 entries (for example, Table 7.3.1.1.2-31A) is adopted to support a maximum of 8 layers (Lₘₐₓ=8).

```
ConfiguredGrantConfig ::= SEQUENCE {
...
  rrc-ConfiguredUplinkGrant SEQUENCE {
    timeDomainOffset INTEGER (0..5119),
    timeDomainAllocation INTEGER (0..15),
    frequencyDomainAllocation BIT STRING (SIZE(18)),
    antennaPort INTEGER (0..31),
    dmrs-SeqInitialization INTEGER(0..1) OPTIONAL, -- Need R
    precodingAndNumberOfLayers INTEGER (0..63),
    srs-ResourceIndicator INTEGER(0..15) OPTIONAL, -- Need R
    srs-ResourceIndicator-r18 INTEGER(0..31) OPTIONAL, -- Need R
    mcsAndTBS INTEGER (0..31),
    frequencyHoppingOffset INTEGER (1.. maxNrofPhysicalResourceBlocks−1) OPTIONAL, -- Need R
    pathlossReferenceIndex INTEGER (0..maxNrofPUSCH-PathlossReferenceRSs−1),
    ...,
    [[
    pusch-RepTypeIndicator-r16 ENUMERATED {pusch-RepTypeA,pusch-RepTypeB} OPTIONAL, -- Need
    M
    frequencyHoppingPUSCH-RepTypeB-r16 ENUMERATED {interRepetition, interSlot} OPTIONAL, --
    Cond RepTypeB
    timeReferenceSFN-r16 ENUMERATED{sfn512} OPTIONAL -- Need S
    ]]
  } OPTIONAL,
...
}
```

The new field can be used for codebook-based or non-codebook based CG PUSCH transmission. As discussed above, codebook-based transmission may be configured by the higher layer parameter txConfig=codebook, and non-codebook-based transmission may be configured by the higher layer parameter txConfig=nonCodebook.

With the above embodiments of the present disclosure, uplink transmission with extended SRS resources is enabled. Further, some embodiments provide methods to support more than 4 SRS resource transmission and/or more than 4 SRS ports per SRS resource for transmission of PUSCH in NR with reduced DCI signaling overhead and SRS resource indication table size. In general, a less signaling overhead, a reduced complexity of system design, a higher throughput, a higher reliability, or a faster response for the uplink transmission may be achieved.

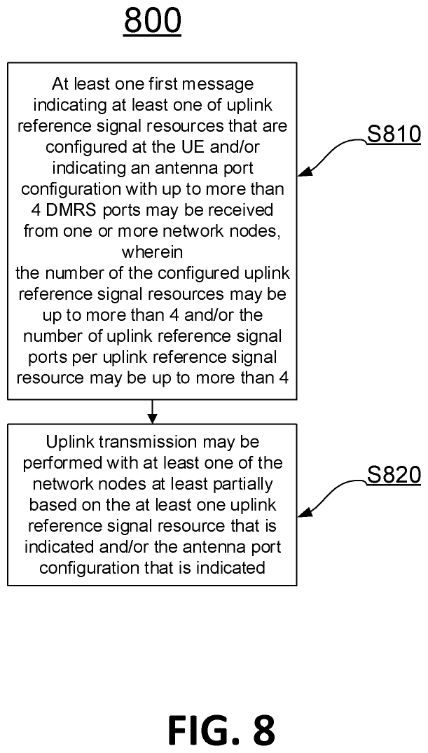

FIG. 8 is a flow chart of an exemplary method 800 at a UE for uplink transmission with extended uplink reference signals resources according to an embodiment of the present disclosure. The method 800 may be performed at a user equipment (e.g., the UE 110). The method 800 may comprise step S810 and S820. However, the present disclosure is not limited thereto. In some other embodiments, the method 800 may comprise more steps, less steps, different steps, or any combination thereof. Further the steps of the method 800 may be performed in a different order than that described herein when multiple steps are involved. Further, in some embodiments, a step in the method 800 may be split into multiple sub-steps and performed by different entities, and/or multiple steps in the method 800 may be combined into a single step.

The method 800 may begin at step S810 where at least one first message indicating at least one of uplink reference signal resources that are configured at the UE and/or indicating an antenna port configuration with up to more than 4 DMRS ports may be received from one or more network nodes. In some embodiments, the number of the configured uplink reference signal resources may be up to more than 4 and/or the number of uplink reference signal ports per uplink reference signal resource may be up to more than 4.

At step S820, uplink transmission may be performed with at least one of the network nodes at least partially based on the at least one uplink reference signal resource that is indicated and/or the antenna port configuration that is indicated.

In some embodiments, before the step S810, the method 800 may further comprise: transmitting, to the one or more network nodes, one or more uplink reference signals over one or more of the uplink reference signal resources. In some embodiments, the step S820 may comprise: determining a first precoder for the uplink transmission at least partially based on the at least one uplink reference signal resource; and performing the uplink transmission at least partially based on the first precoder. In some embodiments, the one or more uplink reference signals may be SRS, the uplink reference signal resources may be SRS resources, and the uplink reference signal ports may be SRS ports. In some embodiments, the at least one first message may comprise at least one of: a DCI message, and an RRC message.

In some embodiments, the uplink transmission may be non-codebook based uplink transmission. In some embodiments, before the step of transmitting the SRSs, the method 800 may further comprise: measuring a downlink reference signal transmitted from at least one of the network nodes; and determining a second precoder for SRS transmission at least partially based on one or more measurements of the downlink reference signal, wherein the step of transmitting the SRSs may comprise: transmitting the SRSs at least partially based on the second precoder. In some embodiments, the downlink reference signal may comprise a CSI-RS.

In some embodiments, the at least one first message may comprise one or more SRI fields, at least one of which indicating at least one of the configured SRS resources. In some embodiments, at least one of the SRI fields may be capable of indicating a subset of possible combinations of the configured SRS resources. In some embodiments, the at least one SRI field may comprise a first number of bits when a second number of SRS resources is configured at the UE, such that the at least one SRI field may not be capable of indicating a full set of possible combinations of the configured SRS resources.

In some embodiments, when a maximum number of layers configured at the UE is 2, at least one of following may be true:—the at least one SRI field comprises 3 bits when 5 SRS resources are configured at the UE; —the at least one SRI field comprises 3 bits when 6 SRS resources are configured at the UE; —the at least one SRI field comprises 4 bits when 7 SRS resources are configured at the UE; and—the at least one SRI field comprises 4 bits when 8 SRS resources are configured at the UE. In some embodiments, the at least one SRI field may be decoded at least partially based on at least one entry of the table 7.

In some embodiments, when a maximum number of layers configured at the UE is 8, at least one of following may be true:—the at least one SRI field comprises 4 bits when 5 SRS resources are configured at the UE; —the at least one SRI field comprises 4 bits when 6 SRS resources are configured at the UE; —the at least one SRI field comprises 5 bits when 7 SRS resources are configured at the UE; and—the at least one SRI field comprises 5 bits when 8 SRS resources are configured at the UE. In some embodiments, the at least one SRI field may be decoded at least partially based on at least one entry of the table 8.

In some embodiments, before the step S810, the method 800 may further comprise: receiving, from at least one of the network nodes, at least one second message indicating at least one subset of possible combinations of the configured SRS resources. In some embodiments, the at least one second message may be a MAC CE message or an RRC message. In some embodiments, the at least one first message may indicate at least one of possible combinations of SRS resources in the at least one subset indicated by the at least one second message. In some embodiments, when a maximum number of layers configured at the UE is 8 and 8 SRS resources are configured at the UE, a set of 255 possible combinations of the configured SRS resources may be divided into 8 subsets, 7 of the 8 subsets each having 32 possible combinations and 1 of the 8 subsets having 31 possible combinations. In some embodiments, the at least one second message may indicate at least one of the 8 subsets. In some embodiments, the at least one SRI field in the at least one first message may comprise 5 bits for indicating a possible combination of SRS resources in the at least one subset indicated by the at least one second message.

In some embodiments, the at least one SRI field may indicate a first combination of SRS resources when a third number of SRS resources is configured at the UE while the at least one SRI field may indicate a second combination of SRS resources when a fourth number of SRS resources is configured at the UE. In some embodiments, the first combination may be different from the second combination. In some embodiments, the third number may be different from the fourth number. In some embodiments, when a maximum number of layers configured at the UE is 2, at least one of following may be true:—the third number is 2 while the fourth number is 5; —the third number is 3 while the fourth number is 6; and—the third number is 4 while the fourth number is 7. In some embodiments, the at least one SRI field may be decoded at least partially based on at least one entry of the table 9.

In some embodiments, the at least one SRI field may be decoded at least partially based on at least one entry of at least one table that is different from SRI indication tables in 3GPP NR Rel-16. In some embodiments, the SRS resources configured at the UE may be indexed according to a predetermined criterion. In some embodiments, the SRS resources configured at the UE may be indexed in an order of channel responses of corresponding downlink reference signals from the strongest to the weakest. In some embodiments, the at least one SRI field may be decoded such that at least one SRS resource having an index lower than that of an SRS resource explicitly indicated by the at least one SRI field may be considered as being implicitly indicated by the at least one SRI field. In some embodiments, the at least one SRI field may be decoded such that any SRS resource having an index lower than that of an SRS resource explicitly indicated by the at least one SRI field may be considered as being implicitly indicated by the at least one SRI field.

In some embodiments, the SRS resources configured at the UE may comprise at least two subsets of SRS resources, and at least one of the subsets may comprise less than or equal to 4 SRS resources. In some embodiments, the at least one first message may comprise at least two SRI fields corresponding to the at least two subsets of SRS resources, and at least one of the SRI fields corresponding to the at least one subset comprising less than or equal to 4 SRS resources may be decoded at least partially based on at least one entry of an existing SRI indication table in 3GPP NR Rel-16. In some embodiments, the SRS resources configured at the UE may comprise at least two subsets of SRS resources, and each of the subsets may comprise less than or equal to 4 SRS resources. In some embodiments, the at least one first message may comprise at least two SRI fields corresponding to the at least two subsets of SRS resources, and each of the SRI fields corresponding to the corresponding subset may be decoded at least partially based on at least one entry of an existing SRI indication table in 3GPP NR Rel-16.

In some embodiments, the SRS resources configured at the UE may comprise at least two subsets of SRS resources for at least two of the network nodes, wherein the at least one first message may comprise at least two SRI fields corresponding to the at least two subsets of SRS resources, wherein the at least two SRI fields may be configured independently of each other. In some embodiments, the at least one first message may comprise at least two messages that are received from at least two of the network nodes, respectively. In some embodiments, the at least one first message may comprise a single message that is received from at least two of the network nodes in a coordinated manner. In some embodiments, the at least two SRI fields may be independently configured by at least two of the network nodes only when the at least two network nodes have different TBs transmitted.

In some embodiments, the uplink transmission may be codebook based uplink transmission. In some embodiments, more than 4 SRS ports may be configured at the UE. In some embodiments, the at least one first message may comprise one or more SRI fields, at least one of which indicating at least one of the configured SRS resources. In some embodiments, the uplink transmission may carry more than one codeword. In some embodiments, the uplink transmission may be at least partially based on an antenna port configuration with up to more than 4 DMRS ports. In some embodiments, the antenna port configuration may be at least partially based on antenna port configuration tables with rank greater than 4. In some embodiments, the uplink transmission may be Type-1 CG based uplink transmission. In some embodiments, the at least one first message may be an RRC message comprising one or more SRI fields, at least one of which indicating at least one of the configured SRS resources. In some embodiments, at least one of the one or more SRI fields may be comprised in a configuredGrantConfig IE. In some embodiments, the at least one SRI field may be an srs-ResourceIndicator-r18IE. In some embodiments, the uplink transmission may be PUSCH transmission. In some embodiments, the network node may comprise at least a TRP.

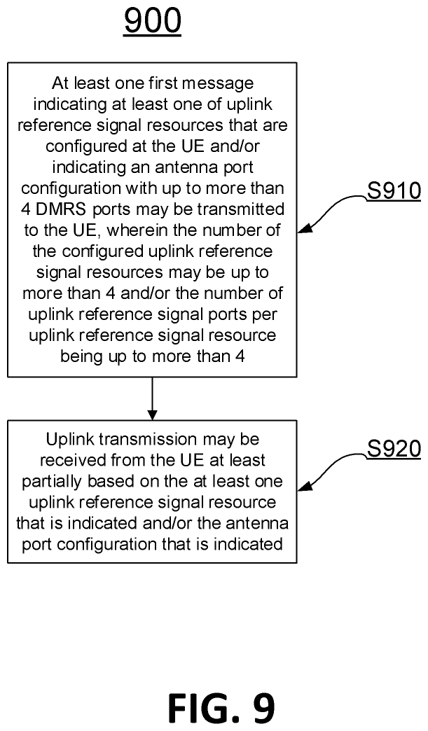

FIG. 9 is a flow chart of an exemplary method 900 at a network node for uplink transmission with extended uplink reference signals resources according to an embodiment of the present disclosure. The method 900 may be performed at a network node (e.g., the gNB 120). The method 900 may comprise step S910 and S920. However, the present disclosure is not limited thereto. In some other embodiments, the method 900 may comprise more steps, less steps, different steps, or any combination thereof. Further the steps of the method 900 may be performed in a different order than that described herein when multiple steps are involved. Further, in some embodiments, a step in the method 900 may be split into multiple sub-steps and performed by different entities, and/or multiple steps in the method 900 may be combined into a single step.

The method 900 may begin at step S910 where at least one first message indicating at least one of uplink reference signal resources that are configured at the UE and/or indicating an antenna port configuration with up to more than 4 DMRS ports may be transmitted to the UE. In some embodiments, the number of the configured uplink reference signal resources may be up to more than 4 and/or the number of uplink reference signal ports per uplink reference signal resource being up to more than 4.

At step S920, uplink transmission may be received from the UE at least partially based on the at least one uplink reference signal resource that is indicated and/or the antenna port configuration that is indicated.

In some embodiments, before the step S910, the method 900 may further comprise: receiving, from the UE, one or more uplink reference signals over one or more of the uplink reference signal resources. In some embodiments, the one or more uplink reference signals may be SRS, the uplink reference signal resources may be SRS resources, and the uplink reference signal ports may be SRS ports. In some embodiments, the at least one first message may comprise at least one of: a DCI message, and an RRC message.

In some embodiments, the uplink transmission may be non-codebook based uplink transmission. In some embodiments, before the step of receiving the SRSs, the method 900 may further comprise: transmitting, to the UE, a downlink reference signal for the UE to determine a second precoder for SRS transmission. In some embodiments, the downlink reference signal may comprise a CSI-RS. In some embodiments, the at least one first message may comprise one or more SRI fields, at least one of which indicating at least one of the configured SRS resources. In some embodiments, at least one of the SRI fields may be capable of indicating a subset of possible combinations of the configured SRS resources.

In some embodiments, the at least one SRI field may comprise a first number of bits when a second number of SRS resources may be configured at the UE, such that the at least one SRI field may not be capable of indicating a full set of possible combinations of the configured SRS resources.

In some embodiments, when a maximum number of layers configured at the UE is 2, at least one of following may be true:—the at least one SRI field comprises 3 bits when 5 SRS resources are configured at the UE; —the at least one SRI field comprises 3 bits when 6 SRS resources are configured at the UE; —the at least one SRI field comprises 4 bits when 7 SRS resources are configured at the UE; and—the at least one SRI field comprises 4 bits when 8 SRS resources are configured at the UE. In some embodiments, the at least one SRI field may be encoded at least partially based on at least one entry of the table 7.

In some embodiments, when a maximum number of layers configured at the UE is 8, at least one of following may be true:—the at least one SRI field comprises 4 bits when 5 SRS resources are configured at the UE; —the at least one SRI field comprises 4 bits when 6 SRS resources are configured at the UE; —the at least one SRI field comprises 5 bits when 7 SRS resources are configured at the UE; and—the at least one SRI field comprises 5 bits when 8 SRS resources are configured at the UE. In some embodiments, the at least one SRI field may be encoded at least partially based on at least one entry of the table 8.

In some embodiments, before the step S910, the method 900 may further comprise: transmitting, to the UE, at least one second message indicating at least one subset of possible combinations of the configured SRS resources. In some embodiments, the at least one second message may be a MAC CE message or an RRC message. In some embodiments, the at least one first message may indicate at least one of possible combinations of SRS resources in the at least one subset indicated by the at least one second message. In some embodiments, when a maximum number of layers configured at the UE is 8 and 8 SRS resources are configured at the UE, a set of 255 possible combinations of the configured SRS resources may be divided into 8 subsets, 7 of the 8 subsets each having 32 possible combinations and 1 of the 8 subsets having 31 possible combinations. In some embodiments, the at least one second message may indicate at least one of the 8 subsets. In some embodiments, the at least one SRI field in the at least one first message may comprise 5 bits for indicating a possible combination of SRS resources in the at least one subset indicated by the at least one second message.

In some embodiments, the at least one SRI field may indicate a first combination of SRS resources when a third number of SRS resources is configured at the UE while the at least one SRI field may indicate a second combination of SRS resources when a fourth number of SRS resources is configured at the UE. In some embodiments, the first combination may be different from the second combination. In some embodiments, the third number may be different from the fourth number.

In some embodiments, when a maximum number of layers configured at the UE is 2, at least one of following may be true:—the third number is 2 while the fourth number is 5; —the third number is 3 while the fourth number is 6; and—the third number is 4 while the fourth number is 7. In some embodiments, the at least one SRI field may be encoded at least partially based on at least one entry of the table 9.

In some embodiments, the at least one SRI field may be encoded at least partially based on at least one entry of at least one table that is different from SRI indication tables in 3GPP NR Rel-16. In some embodiments, the SRS resources configured at the UE may be indexed according to a predetermined criterion. In some embodiments, the SRS resources configured at the UE may be indexed in an order of channel responses of corresponding downlink reference signals from the strongest to the weakest. In some embodiments, the at least one SRI field may be encoded such that at least one SRS resource having an index lower than that of an SRS resource explicitly indicated by the at least one SRI field is considered as being implicitly indicated by the at least one SRI field. In some embodiments, the at least one SRI field may be encoded such that any SRS resource having an index lower than that of an SRS resource explicitly indicated by the at least one SRI field may be considered as being implicitly indicated by the at least one SRI field.

In some embodiments, the SRS resources configured at the UE may comprise at least two subsets of SRS resources, and at least one of the subsets may comprise less than or equal to 4 SRS resources. In some embodiments, the at least one first message may comprise at least two SRI fields corresponding to the at least two subsets of SRS resources, and at least one of the SRI fields corresponding to the at least one subset comprising less than or equal to 4 SRS resources may be encoded at least partially based on at least one entry of an existing SRI indication table in 3GPP NR Rel-16. In some embodiments, the SRS resources configured at the UE may comprise at least two subsets of SRS resources, and each of the subsets may comprise less than or equal to 4 SRS resources. In some embodiments, the at least one first message may comprise at least two SRI fields corresponding to the at least two subsets of SRS resources, and each of the SRI fields corresponding to the corresponding subset may be encoded at least partially based on at least one entry of an existing SRI indication table in 3GPP NR Rel-16.

In some embodiments, the SRS resources configured at the UE may comprise at least two subsets of SRS resources for at least two of the network nodes. In some embodiments, the at least one first message may comprise at least two SRI fields corresponding to the at least two subsets of SRS resources. In some embodiments, the at least two SRI fields may be configured independently of each other. In some embodiments, the at least one first message may comprise at least two messages that are received from at least two of the network nodes, respectively. In some embodiments, the at least one first message may comprise a single message that is received from at least two of the network nodes in a coordinated manner. In some embodiments, the at least two SRI fields may be independently configured by at least two of the network nodes only when the at least two network nodes have different TBs transmitted.

In some embodiments, the uplink transmission may be codebook based uplink transmission. In some embodiments, more than 4 SRS ports may be configured at the UE. In some embodiments, the at least one first message may comprise one or more SRI fields, at least one of which indicating at least one of the configured SRS resources. In some embodiments, the uplink transmission may carry more than one codeword. In some embodiments, the uplink transmission may be at least partially based on an antenna port configuration with up to more than 4 DMRS ports. In some embodiments, the antenna port configuration may be at least partially based on antenna port configuration tables with rank greater than 4. In some embodiments, the uplink transmission may be Type-1 CG based uplink transmission. In some embodiments, the at least one first message may be an RRC message comprising one or more SRI fields, at least one of which indicating at least one of the configured SRS resources. In some embodiments, at least one of the one or more SRI fields may be comprised in a configuredGrantConfig IE. In some embodiments, the at least one SRI field may be an srs-ResourceIndicator-r18IE. In some embodiments, the uplink transmission may be PUSCH transmission. In some embodiments, the network node may comprise at least a TRP.

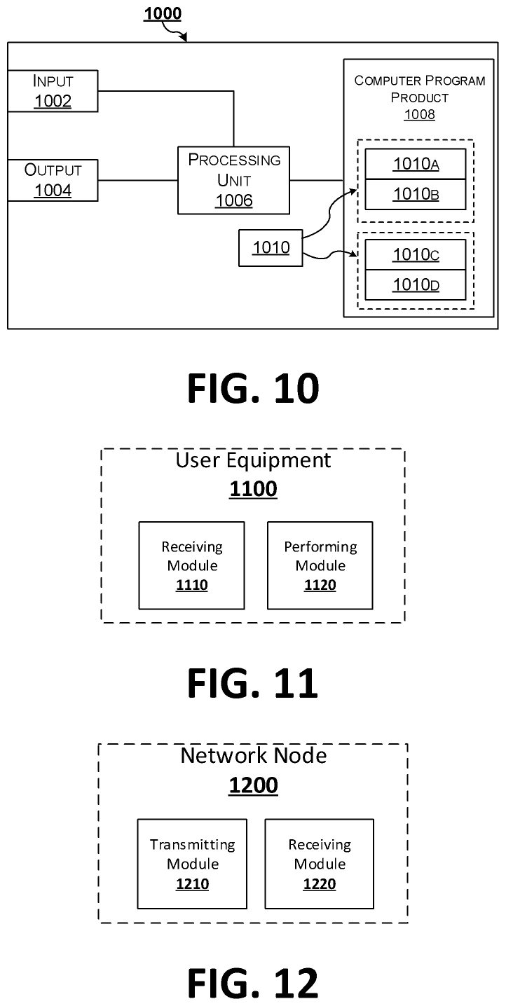

FIG. 10 schematically shows an embodiment of an arrangement 1000 which may be used in a user equipment (e.g., the UE 110) or a network node (e.g., the gNB 120) according to an embodiment of the present disclosure. Comprised in the arrangement 1000 are a processing unit 1006, e.g., with a Digital Signal Processor (DSP) or a Central Processing Unit (CPU). The processing unit 1006 may be a single unit or a plurality of units to perform different actions of procedures described herein. The arrangement 1000 may also comprise an input unit 1002 for receiving signals from other entities, and an output unit 1004 for providing signal(s) to other entities. The input unit 1002 and the output unit 1004 may be arranged as an integrated entity or as separate entities.

Furthermore, the arrangement 1000 may comprise at least one computer program product 1008 in the form of a non-volatile or volatile memory, e.g., an Electrically Erasable Programmable Read-Only Memory (EEPROM), a flash memory and/or a hard drive. The computer program product 1008 comprises a computer program 1010, which comprises code/computer readable instructions, which when executed by the processing unit 1006 in the arrangement 1000 causes the arrangement 1000 and/or the UE/network node in which it is comprised to perform the actions, e.g., of the procedure described earlier in conjunction with FIG. 6 to FIG. 9 or any other variant.

The computer program 1010 may be configured as a computer program code structured in computer program modules 1010A and 1010B. Hence, in an exemplifying embodiment when the arrangement 1000 is used in a UE, the code in the computer program of the arrangement 1000 includes: a module 1010A for receiving, from one or more network nodes, at least one first message indicating at least one of uplink reference signal resources that are configured at the UE and/or indicating an antenna port configuration with up to more than 4 DMRS ports, the number of the configured uplink reference signal resources being up to more than 4 and/or the number of uplink reference signal ports per uplink reference signal resource being up to more than 4; and a module 1010B for performing, with at least one of the network nodes, uplink transmission at least partially based on the at least one uplink reference signal resource that is indicated and/or the antenna port configuration that is indicated.

Further, the computer program 1010 may be further configured as a computer program code structured in computer program modules 1010C and 1010D. Hence, in an exemplifying embodiment when the arrangement 1000 is used in a network node, the code in the computer program of the arrangement 1000 includes: a module 1010C for transmitting, to the UE, at least one first message indicating at least one of uplink reference signal resources that are configured at the UE and/or indicating an antenna port configuration with up to more than 4 DMRS ports, the number of the configured uplink reference signal resources being up to more than 4 and/or the number of uplink reference signal ports per uplink reference signal resource being up to more than 4; and a module 1010D for receiving, from the UE, uplink transmission at least partially based on the at least one uplink reference signal resource that is indicated and/or the antenna port configuration that is indicated.

The computer program modules could essentially perform the actions of the flow illustrated in FIG. 6 to FIG. 9, to emulate the UE or the network node. In other words, when the different computer program modules are executed in the processing unit 1006, they may correspond to different modules in the UE or the network node.

Although the code means in the embodiments disclosed above in conjunction with FIG. 10 are implemented as computer program modules which when executed in the processing unit causes the arrangement to perform the actions described above in conjunction with the figures mentioned above, at least one of the code means may in alternative embodiments be implemented at least partly as hardware circuits.

The processor may be a single CPU (Central processing unit), but could also comprise two or more processing units. For example, the processor may include general purpose microprocessors; instruction set processors and/or related chips sets and/or special purpose microprocessors such as Application Specific Integrated Circuit (ASICs). The processor may also comprise board memory for caching purposes. The computer program may be carried by a computer program product connected to the processor. The computer program product may comprise a computer readable medium on which the computer program is stored. For example, the computer program product may be a flash memory, a Random-access memory (RAM), a Read-Only Memory (ROM), or an EEPROM, and the computer program modules described above could in alternative embodiments be distributed on different computer program products in the form of memories within the UE or the network node.

Correspondingly to the method 800 as described above, an exemplary user equipment is provided. FIG. 11 is a block diagram of a UE 1100 according to an embodiment of the present disclosure. The UE 1100 may be, e.g., the UE 110 in some embodiments.

The UE 1100 may be configured to perform the method 800 as described above in connection with FIG. 8. As shown in FIG. 11, the UE 1100 may comprise a receiving module 1110 for receiving, from one or more network nodes, at least one first message indicating at least one of uplink reference signal resources that are configured at the UE and/or indicating an antenna port configuration with up to more than 4 DMRS ports, the number of the configured uplink reference signal resources being up to more than 4 and/or the number of uplink reference signal ports per uplink reference signal resource being up to more than 4; and a performing module 1120 for performing, with at least one of the network nodes, uplink transmission at least partially based on the at least one uplink reference signal resource that is indicated and/or the antenna port configuration that is indicated.

The above modules 1110 and/or 1120 may be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIG. 8. Further, the UE 1100 may comprise one or more further modules, each of which may perform any of the steps of the method 800 described with reference to FIG. 8.

Correspondingly to the method 900 as described above, a network node is provided. FIG. 12 is a block diagram of an exemplary network node 1200 according to an embodiment of the present disclosure. The network node 1200 may be, e.g., the gNB 120 in some embodiments.

The network node 1200 may be configured to perform the method 900 as described above in connection with FIG. 9. As shown in FIG. 12, the network node 1200 may comprise a transmission module 1210 for transmitting, to the UE, at least one first message indicating at least one of uplink reference signal resources that are configured at the UE and/or indicating an antenna port configuration with up to more than 4 DMRS ports, the number of the configured uplink reference signal resources being up to more than 4 and/or the number of uplink reference signal ports per uplink reference signal resource being up to more than 4; and a performing module 1220 for receiving, from the UE, uplink transmission at least partially based on the at least one uplink reference signal resource that is indicated and/or the antenna port configuration that is indicated.

The above modules 1210 and 1220 may be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIG. 9. Further, the network node 1200 may comprise one or more further modules, each of which may perform any of the steps of the method 900 described with reference to FIG. 9.

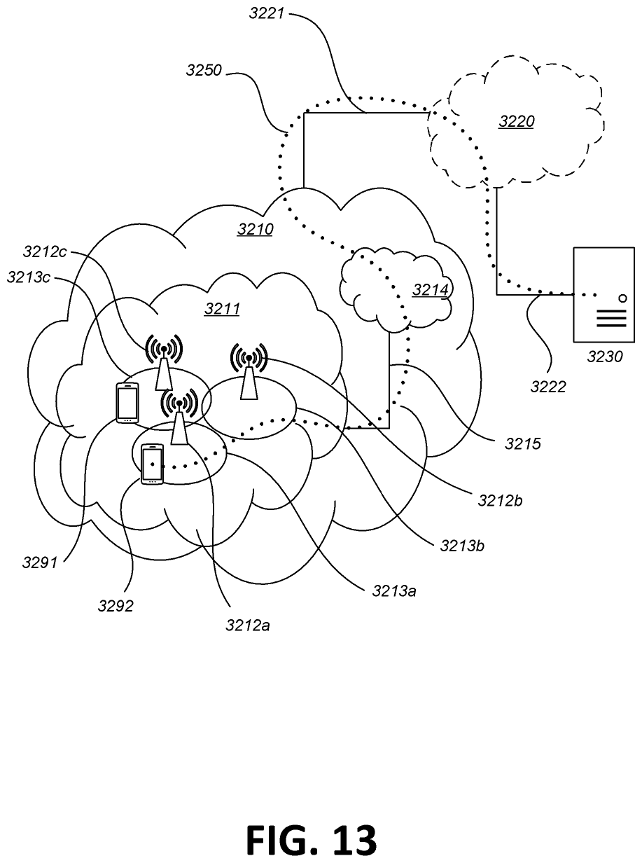

With reference to FIG. 13, in accordance with an embodiment, a communication system includes a telecommunication network 3210, such as a 3GPP-type cellular network, which comprises an access network 3211, such as a radio access network, and a core network 3214. The access network 3211 comprises a plurality of base stations 3212a, 3212b, 3212c, such as NBs, eNBs, gNBs or other types of wireless access points, each defining a corresponding coverage area 3213a, 3213b, 3213c. Each base station 3212a, 3212b, 3212c is connectable to the core network 3214 over a wired or wireless connection 3215. A first UE 3291 located in coverage area 3213c is configured to wirelessly connect to, or be paged by, the corresponding base station 3212c. A second UE 3292 in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 13 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signaling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

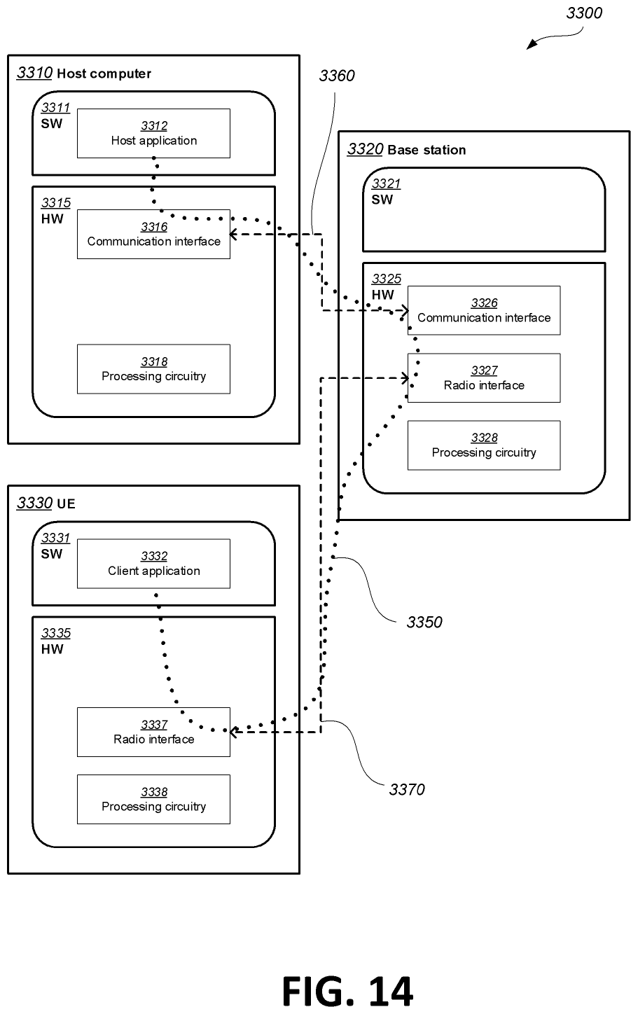

Example implementations, in accordance with an embodiment, of the UE, base station and host computer discussed in the preceding paragraphs will now be described with reference to FIG. 14. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown in FIG. 14) served by the base station 3320. The communication interface 3326 may be configured to facilitate a connection 3360 to the host computer 3310. The connection 3360 may be direct or it may pass through a core network (not shown in FIG. 14) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides.

It is noted that the host computer 3310, base station 3320 and UE 3330 illustrated in FIG. 14 may be identical to the host computer 3230, one of the base stations 3212a, 3212b, 3212c and one of the UEs 3291, 3292 of FIG. 13, respectively. This is to say, the inner workings of these entities may be as shown in FIG. 14 and independently, the surrounding network topology may be that of FIG. 13.

In FIG. 14, the OTT connection 3350 has been drawn abstractly to illustrate the communication between the host computer 3310 and the use equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g., on the basis of load balancing consideration or reconfiguration of the network).

The wireless connection 3370 between the UE 3330 and the base station 3320 is in accordance with the teachings of the embodiments described throughout this disclosure One or more of the various embodiments improve the performance of OTT services provided to the UE 3330 using the OTT connection 3350, in which the wireless connection 3370 forms the last segment. More precisely, the teachings of these embodiments may improve the latency and power consumption and thereby provide benefits such as reduced user waiting time, better responsiveness, extended battery lifetime.

A measurement procedure may be provided for the purpose of monitoring data rate, latency, and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signaling facilitating the host computer's 3310 measurements of throughput, propagation times, latency, and the like. The measurements may be implemented in that the software 3311, 3331 causes messages to be transmitted, in particular empty or ‘dummy’ messages, using the OTT connection 3350 while it monitors propagation times, errors etc.

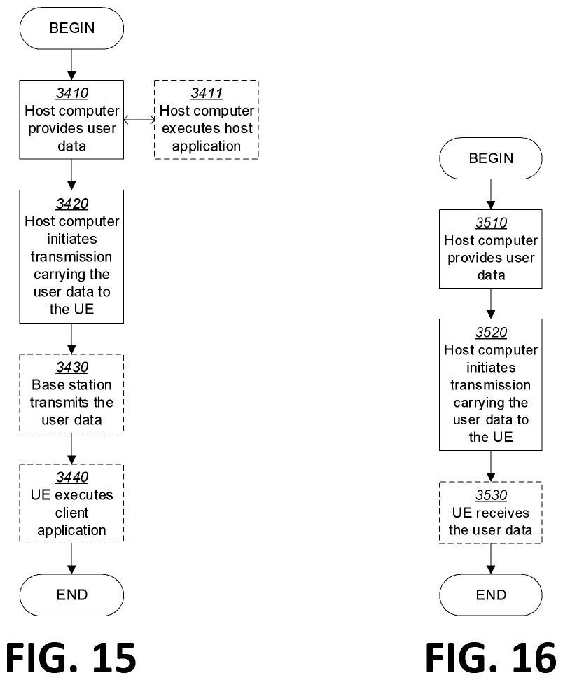

FIG. 15 is a flowchart illustrating a method implemented in a communication system, in accordance with one embodiment. The communication system includes a host computer, a base station and a UE which may be those described with reference to FIG. 13 and FIG. 14. For simplicity of the present disclosure, only drawing references to FIG. 15 will be included in this section. In a first step 3410 of the method, the host computer provides user data. In an optional substep 3411 of the first step 3410, the host computer provides the user data by executing a host application. In a second step 3420, the host computer initiates a transmission carrying the user data to the UE. In an optional third step 3430, the base station transmits to the UE the user data which was carried in the transmission that the host computer initiated, in accordance with the teachings of the embodiments described throughout this disclosure. In an optional fourth step 3440, the UE executes a client application associated with the host application executed by the host computer.

FIG. 16 is a flowchart illustrating a method implemented in a communication system, in accordance with one embodiment. The communication system includes a host computer, a base station and a UE which may be those described with reference to FIG. 13 and FIG. 14. For simplicity of the present disclosure, only drawing references to FIG. 16 will be included in this section. In a first step 3510 of the method, the host computer provides user data. In an optional substep (not shown) the host computer provides the user data by executing a host application. In a second step 3520, the host computer initiates a transmission carrying the user data to the UE. The transmission may pass via the base station, in accordance with the teachings of the embodiments described throughout this disclosure. In an optional third step 3530, the UE receives the user data carried in the transmission.

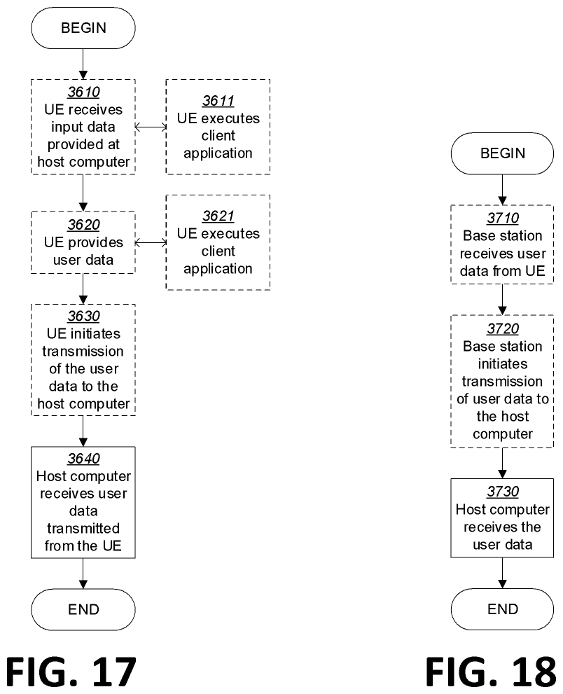

FIG. 17 is a flowchart illustrating a method implemented in a communication system, in accordance with one embodiment. The communication system includes a host computer, a base station and a UE which may be those described with reference to FIG. 13 and FIG. 14. For simplicity of the present disclosure, only drawing references to FIG. 17 will be included in this section. In an optional first step 3610 of the method, the UE receives input data provided by the host computer. Additionally or alternatively, in an optional second step 3620, the UE provides user data. In an optional substep 3621 of the second step 3620, the UE provides the user data by executing a client application. In a further optional substep 3611 of the first step 3610, the UE executes a client application which provides the user data in reaction to the received input data provided by the host computer. In providing the user data, the executed client application may further consider user input received from the user. Regardless of the specific manner in which the user data was provided, the UE initiates, in an optional third substep 3630, transmission of the user data to the host computer. In a fourth step 3640 of the method, the host computer receives the user data transmitted from the UE, in accordance with the teachings of the embodiments described throughout this disclosure.

FIG. 18 is a flowchart illustrating a method implemented in a communication system, in accordance with one embodiment. The communication system includes a host computer, a base station and a UE which may be those described with reference to FIG. 13 and FIG. 14. For simplicity of the present disclosure, only drawing references to FIG. 18 will be included in this section. In an optional first step 3710 of the method, in accordance with the teachings of the embodiments described throughout this disclosure, the base station receives user data from the UE. In an optional second step 3720, the base station initiates transmission of the received user data to the host computer. In a third step 3730, the host computer receives the user data carried in the transmission initiated by the base station.

The present disclosure is described above with reference to the embodiments thereof. However, those embodiments are provided just for illustrative purpose, rather than limiting the present disclosure. The scope of the disclosure is defined by the attached claims as well as equivalents thereof. Those skilled in the art can make various alternations and modifications without departing from the scope of the disclosure, which all fall into the scope of the disclosure.

| Abbreviation | Explanation |
|---|---|
| BS | Base station |
| CB | Code Block |
| CBG | Code Block Group |
| CBGTI | Code Block Group Transmission Information |
| CG | Configured Grant |
| CRC | Cyclic Redundancy Check |
| CRM | Contention Resolution Message |
| CSI | Channel State Information |
| DCI | Downlink Control Information |
| DG | Dynamic Grant |
| DL | Downlink |
| DM-RS | Demodulation Reference Signal |
| eMTC | Enhanced Machine Type Communication |
| FH | Frequency Hopping |
| FR1 | Frequency Range 1 |
| FR2 | Frequency Range 2 |
| gNB | Network Node in NR |
| HARQ | Hybrid Automated Retransmission Request |
| MAC | Medium Access Control |
| Msg3 | Message 3 |
| NB-IoT | Narrow-Band Internet of Things |
| NR | New Radio |
| PDCCH | Physical Downlink Control Channel |
| PUSCH | Physical Uplink Shared Data Channel |
| PRB | Physical Resource Block, i.e., 12 consecutive subcarriers |
| RE | Resource Element |
| RNTI | Radio Network Temporary Identifier |
| RSRP | Reference Signal Received Power |
| RV | Redundancy Version |
| SRI | SRS Resource Indication |
| SRS | Sounding Reference Signal |
| TB | Transport Block |
| TBS | TB Size |
| TxD | Transmit Diversity |
| UE | User Equipment |
| UL | Uplink |

1. A method at a user equipment (UE) for uplink transmission, the method comprising:
receiving, from one or more network nodes, at least one first message indicating at least one of uplink reference signal resources that are configured at the UE and/or indicating an antenna port configuration with up to more than 4 demodulation reference signal ports, the number of the configured uplink reference signal resources being up to more than 4 and/or the number of uplink reference signal ports per uplink reference signal resource being up to more than 4; and
performing, with at least one of the network nodes, uplink transmission at least partially based on the at least one uplink reference signal resource that is indicated and/or the antenna port configuration that is indicated.

2. The method of claim 1, wherein before the step of receiving the at least one first message, the method further comprises:
transmitting, to the one or more network nodes, one or more uplink reference signals over one or more of the uplink reference signal resources.

3. The method of claim 1, wherein the step of performing the uplink transmission comprises:
determining a first precoder for the uplink transmission at least partially based on the at least one uplink reference signal resource; and
performing the uplink transmission at least partially based on the first precoder.

4. The method of claim 1, wherein the one or more uplink reference signals are Sounding Reference Signal (SRS), the uplink reference signal resources are SRS resources, and the uplink reference signal ports are SRS ports.

5. The method of claim 1, wherein the at least one first message comprises at least one of: a Downlink Control Information (DCI) message, and a Radio Resource Control (RRC) message.

6. The method of claim 1, wherein the uplink transmission is non-codebook based uplink transmission.

7. The method of claim 6, wherein before the step of transmitting the SRSs, the method further comprises:
measuring a downlink reference signal transmitted from at least one of the network nodes; and
determining a second precoder for SRS transmission at least partially based on one or more measurements of the downlink reference signal,
wherein the step of transmitting the SRSs comprises:
transmitting the SRSs at least partially based on the second precoder.

8. The method of claim 7, wherein the downlink reference signal comprises a Channel State Information—Reference Signal (CSI-RS).

9. The method of claim 1, wherein the at least one first message comprises one or more SRS resource indicator (SRI) fields, at least one of which indicating at least one of the configured SRS resources.

10-33. (canceled)

34. The method of claim 1, wherein the uplink transmission is codebook based uplink transmission.

35. The method of claim 34, wherein more than 4 SRS ports are configured at the UE,
wherein the at least one first message comprises one or more SRI fields, at least one of which indicating at least one of the configured SRS resources.

36. The method of claim 34, wherein the uplink transmission carries more than one codeword.

37. The method of claim 1, wherein the uplink transmission is at least partially based on an antenna port configuration with up to more than 4 Demodulation Reference Signal (DMRS) ports.

38. The method of claim 37, wherein the antenna port configuration is at least partially based on antenna port configuration tables with rank greater than 4.

39-44. (canceled)

45. A user equipment (UE), comprising:
a processor;
a memory storing instructions which, when executed by the processor, cause the UE to
receive, from one or more network nodes, at least one first message indicating at least one of uplink reference signal resources that are configured at the UE and/or indicating an antenna port configuration with up to more than 4 demodulation reference signal ports, the number of the configured uplink reference signal resources being up to more than 4 and/or the number of uplink reference signal ports per uplink reference signal resource being up to more than 4; and
perform, with at least one of the network nodes, uplink transmission at least partially based on the at least one uplink reference signal resource that is indicated and/or the antenna port configuration that is indicated.

46. A method at a network node for uplink transmission with a UE, the method comprising:
transmitting, to the UE, at least one first message indicating at least one of uplink reference signal resources that are configured at the UE and/or indicating an antenna port configuration with up to more than 4 DMRS ports, the number of the configured uplink reference signal resources being up to more than 4 and/or the number of uplink reference signal ports per uplink reference signal resource being up to more than 4; and
receiving, from the UE, uplink transmission at least partially based on the at least one uplink reference signal resource that is indicated and/or the antenna port configuration that is indicated.

47-77. (canceled)

78. The method of claim 46, wherein the uplink transmission is codebook based uplink transmission.

79. The method of claim 78, wherein more than 4 SRS ports are configured at the UE,
wherein the at least one first message comprises one or more SRI fields, at least one of which indicating at least one of the configured SRS resources.

80. The method of claim 78, wherein the uplink transmission carries more than one codeword.

81. The method of claim 46, wherein the uplink transmission is at least partially based on an antenna port configuration with up to more than 4 DMRS ports.

82-92. (canceled)
